(19) United States
(12) Patent Application Publication
(10) Pub. No.: US 2007/0279182 A1
(43) Pub. Date: Dec. 6, 2007

(54) Printed resistors and processes for forming same

(75) Inventors: Toivo T. Kodas, Albuquerque, NM (US); Chuck Edwards, Rio Rancho, NM (US); Klaus Kunze, Albuquerque, NM (US); Hyungrak Kim, Albuquerque, NM (US); Ned Jay Hardman, Albuquerque, NM (US)

Correspondence Address: Jaimes Sher, Esq.;Cabot Corporation, 5401 Venice Avenue NE, Albuquerque, NM, 87113, US

(73) Assignee: Cabot Corporation, Boston, MA (US)

(21) Appl. No.: 11/443,131

(22) Filed: May 31, 2006

(51) Int. Cl. H01C 7/13

(52) U.S. Cl. 338/22 R

(57) ABSTRACT

The invention is to printed resistors and processes for forming same. The resistors comprise a conductive phase, preferably comprising conductive nanoparticles, and a resistive phase. In the processes of the invention, a resistor may be formed from a single ink or a plurality of inks. In the single ink embodiment, an ink is deposited which comprises a conductive phase precursor, a resistive phase precursor and a vehicle. The vehicle in removed and the conductive and resistive phase precursors are converted to a conductive phase and a resistive phase, respectively. In the multiple ink embodiment, a first ink comprising the conductive phase precursor and a first vehicle and a second ink comprising the resistive phase precursor and a second vehicle are deposited on the substrate. The vehicles are removed and the conductive and resistive phase precursors are converted to a conductive phase and a resistive phase, respectively.

### FIELD OF THE INVENTION

The present invention relates to resistors. More particularly, the invention relates to printed-resistors, processes for forming printed resistors, preferably in a direct write deposition process.

### BACKGROUND OF THE INVENTION

The electronics, display and energy industries rely on the formation of coatings and patterns of electronic features to form circuits on organic and inorganic substrates. The primary methods for generating these patterns include screen printing for features larger than about 100 μm and thin film and etching methods for features smaller than about 100 μm. Other subtractive methods to attain fine feature sizes include the use of photo-patternable pastes and laser trimming.

One consideration with respect to patterning of electronic features is cost. Non-vacuum, additive methods generally entail lower costs than vacuum and subtractive approaches. Some of these printing approaches utilize high viscosity flowable liquids. Screen-printing, for example, uses flowable mediums with viscosities of thousands of centipoise. At the other extreme, low viscosity compositions can be deposited by methods such as ink-jet printing. However, low viscosity compositions are not as well developed as the high viscosity compositions.

Ink-jet printing of conductive electronic features has been explored. The need remains, however, for producing well-defined printable resistive electronic features, particularly at relatively low temperatures.

The need also exists for compositions, e.g., inks, for the fabrication of electrical resistors for use in electronics, displays, and other applications. Further, there is a need for compositions, e.g., inks, for forming resistors, which compositions may be processed to form resistors at low temperatures thereby allowing deposition onto high-temperature sensitive organic substrates:

Further, there is a need for electronic circuit elements, particularly electrical resistors, and complete electronic circuits incorporating such resistors, on inexpensive, thin and/or flexible substrates, such as paper, using high volume printing techniques.

### SUMMARY OF THE INVENTION

In one embodiment, the present invention is directed to a resistor, comprising a network of interconnected conductive nodes and resistive nodes, wherein the conductive nodes comprise conductive nanoparticles, and wherein the resistive nodes comprise resistive particles, the network defining a plurality of pores having an average pore volume of less than about 10,000,000 nm³, and the resistor having a resistivity of greater than 100 μΩ-cm, e.g., greater than 1,000 μΩ-cm or greater than 1,000,000 μΩ-cm. A majority of the conductive nanoparticles optionally are fused to at least one adjacent conductive nanoparticle. The conductive nanoparticles optionally have an average particle size of from about 20 to about 500 nm. The resistive particles optionally comprise carbon nanoparticles, e.g., modified carbon black. The weight ratio of the conductive phase to the resistive phase optionally increases from a first point on the resistor to a second point on the resistor. The resistor optionally further comprises a binder comprising PEDOT.

In a preferred embodiment, the conductive nanoparticles comprise metallic nanoparticles, optionally comprising a metal selected from the group consisting of silver, gold, copper, nickel, cobalt, palladium, platinum, indium, tin, zinc, titanium, chromium, tantalum, tungsten, iron, rhodium, iridium, ruthenium, osmium, aluminum and lead. The metallic nanoparticles optionally comprise an alloy comprising at least two metals, each of the two metals being selected from the group consisting of silver, gold, copper, nickel, cobalt, palladium, platinum, indium, tin, zinc, titanium, chromium, tantalum, tungsten, iron, rhodium, iridium, ruthenium, osmium, aluminum and lead. In another embodiment, the metallic nanoparticles comprise an alloy comprising a combination of metals selected from the group consisting of silver/nickel, silver/copper, silver/cobalt, platinum/copper, platinum/ruthenium, platinum/iridium, platinum/gold, palladium/gold, palladium/silver, nickel/copper, nickel/chromium, and titanium/palladium/gold. Optionally, the conductive nanoparticles comprise a metal ruthenate.

In another embodiment, conductive nanoparticles comprise modified carbon black. In this embodiment, the resistive particles optionally comprise insulator nanoparticles, optionally insulator nanoparticles selected from the group consisting of silica particles, alumina particles, titania particles, borosilicate glass particles, lead borosilicate glass particles, and lead free glass particles. The insulator nanoparticles optionally are functionalized with functional groups, optionally functional groups selected from the groups consisting of acrylate groups, perfluoro groups, alcohol groups, epoxide groups and aliphatic alkane groups.

In another embodiment, the invention is to a resistor, comprising: (a) a conductive phase disposed on a substrate, the conductive phase comprising conductive nanoparticles; and (b) a resistive phase in electrical communication with the conductive phase. The resistive phase optionally comprises a fusing material that has a conductivity less than the conductivity of the conductive phase and which connects adjacent conductive nanoparticles to one another. In another embodiment, the resistor comprises interconnected particles having core/shell structures, wherein the cores comprise the conductive phase and the shells comprise the resistive phase. The cores optionally comprise a metal selected from the group consisting of silver, nickel and copper, and wherein the shells comprise silica. The resistive phase optionally is separate from the conductive phase, e.g., longitudinally oriented, at least in part, with respect to the conductive phase or laterally oriented, at least in part, with respect to the conductive phase. In one embodiment, the resistor comprises multiple conductive phases and multiple resistive phases alternating longitudinally with respect to one another, optionally as a checkerboard pattern of alternating conductive phases and resistive phases.

In another embodiment, the invention is to a process for forming a resistor (e.g., an above-described resistor), the process comprising the steps of: (a) providing an ink comprising a conductive phase precursor, a resistive phase precursor and a vehicle; (b) depositing the ink on a substrate; (c) removing a majority of the vehicle from the deposited ink; (d) converting the conductive phase precursor to a conductive phase; and (e) converting the resistive phase precursor to a resistive phase, steps (c), (d) and (e) optionally occurring at least partially simultaneously. The process optionally comprises heating the deposited ink and/or curing the deposited ink with UV radiation. The depositing preferably comprises direct write printing, e.g., piezo-electric, thermal, drop-on-demand or continuous ink jet printing, the ink onto the substrate.

In another embodiment, the invention is to a process for forming a resistor (e.g., an above-described resistor), the process comprising the steps of: (a) providing a first ink comprising a conductive phase precursor and a first vehicle; (b) providing a second ink comprising a resistive phase precursor and a second vehicle; (c) depositing the first ink and the second ink on a substrate; (d) removing a majority of the first vehicle and a majority of the second vehicle from the deposited first and second inks; and (e) converting the conductive phase precursor to a conductive phase; and (f) converting the resistive phase precursor to a resistive phase, steps (d), (e) and (f) optionally occurring at least partially simultaneously. The conductive phase precursor optionally comprises conductive nanoparticles. The process optionally comprises heating at least one of the deposited first ink or the deposited second ink and/or curing at least one of the deposited first ink or the deposited second ink with UV radiation. The depositing preferably comprises direct write printing, e.g., piezo-electric, thermal, drop-on-demand or continuous ink jet printing, at least one of the first ink or the second ink onto the substrate. The first ink may be deposited before, after or simultaneously with the second ink. The removing of the majority of the first vehicle optionally occurs before the depositing of the second ink. In another embodiment, the removing of the majority of the second vehicle occurs before the depositing of the first ink. The first ink and the second ink optionally are deposited within about 30 seconds of one another, optionally so that the first ink and the second ink blend with one another after step (c).

### BRIEF DESCRIPTION OF THE DRAWINGS

The present invention will be better understood in view of the following non-limiting figures, wherein:

FIGS. 1a, 1b and 1c illustrate a positional layout of a resistor fabricated using an ink-jet printer according to one embodiment of the present invention;

FIGS. 2a, 2b and 2c illustrate another positional layout of a resistor fabricated using an ink-jet printer according to one embodiment of the present invention;

FIG. 3 illustrates a positional layout of a resistor having a resistivity gradient that is fabricated using an ink-jet printer according to another embodiment of the invention; and

FIG. 4 illustrates a positional layout of another exemplary resistor having a resistivity gradient that is fabricated using an ink-jet printer according to another embodiment of the present invention.

### DETAILED DESCRIPTION OF THE INVENTION

### I. Resistors

In a first embodiment, the invention is to a resistor, comprising a network of electrically interconnected conductive nodes and resistive nodes. The conductive nodes comprise conductive nanoparticles, e.g., metallic or non-metallic conductive nanoparticles, which form a conductive phase. The resistive nodes comprise resistive particles, optionally resistive nanoparticles, which form a resistive phase. The network defines a plurality of pores having an average pore volume of less than about 10,000,000 nm³, e.g., less than about 1,000,000 nm³ or less than about 100,000 nm³. The resistor has a resistivity of greater than 100 μΩ-cm, e.g., greater than 1,000 μΩ-cm, greater than about 10,000 μΩ-cm, greater than about 100,000 μΩ-cm, or greater than about 1,000,000 μΩ-cm. In a preferred embodiment, a majority of the conductive nanoparticles are fused to at least one adjacent conductive nanoparticle and/or to at least one adjacent resistive particle. Optionally, a majority of the resistive particles are fused to at least one adjacent resistive particle and/or to at least one adjacent conductive nanoparticle.

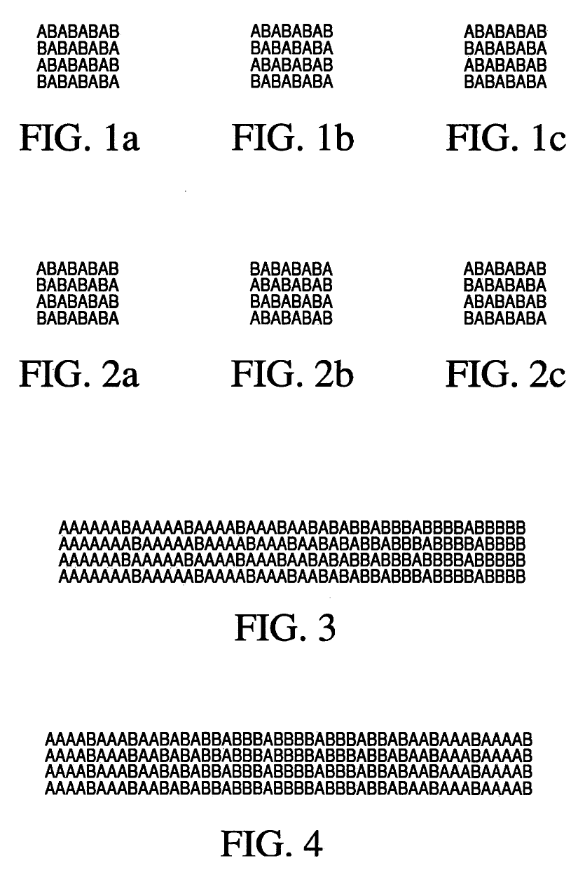

In a second embodiment, the invention is to a resistor comprising a conductive phase comprising conductive nanoparticles and a resistive phase in electrical communication with the conductive phase. The resistive phase optionally is separate from the conductive phase. In this context, by “separate” it is meant that the conductive and resistive phases are discernable from one another without the need of sophisticated analytic equipment, e.g., without X-ray diffraction spectrometry, although the phases might not be discernable with the naked eye. It is contemplated that an unsophisticated optical device, e.g., a magnifying glass or microscope, may be necessary to discern the two separate phases. For example, the resistor of this embodiment optionally comprises multiple conductive phases and multiple resistive phases alternating longitudinally with respect to one another. In this embodiment, the conductive phase may be formed from a first ink and the resistive phase may be formed from a second ink deposited adjacent to and/or on top of the first ink, as shown, for example in FIGS. 1a-1c and 2a-2c, discussed below. Alternatively, the resistive phase may be formed from a second ink and the conductive phase may be formed from a first ink that is deposited adjacent to and/or on top of the second ink. The electrical characteristics of the resistors formed from this process may vary widely depending, for example, on the various patterns in which the first and second inks are printed. Processes and non-limiting exemplary patterns for forming such resistors are described below with reference to the figures that are appended hereto.

In either embodiment, the conductive phase comprises conductive nanoparticles. As used herein, the term “nanoparticles” means particles having an average particle size less than 1 μm (excluding capping agent, if any, as described below). The conductive nanoparticles may be metallic or non-metallic.

In one embodiment, the conductive nanoparticles in the conductive phase are highly conductive. For example, the conductive nanoparticles optionally comprise metallic nanoparticles comprising a metallic composition that exhibits a low bulk resistivity (in the absence of the resistive phase) such as, e.g., a bulk resistivity of less than about 25 μΩ-cm, e.g., less than about 15 μΩ-cm, less than about 10 μΩ-cm, or less than about 5 μΩ-cm. In another embodiment, the conductive nanoparticles are semiconductive. For example, the conductive nanoparticles optionally exhibit a bulk resistivity (in the absence of the resistive phase) of from about 100 to about 100000 μΩ-cm.

The amount of the conductive nanoparticles contained in the resistor may vary depending, for example, on the desired electrical characteristics of the resistor, and the respective conductivity/resistivity of the conductive phase and resistive phase. In various non-limiting embodiments, the resistor comprises the conductive nanoparticles in an amount ranging from about 3 vol wt % to about 95 vol wt %, e.g., from about 10 vol wt. % to about 80 vol wt %, or from about 15 vol wt. % to about 60 vol wt. %, based on the total weight of the resistor.

The size of the conductive nanoparticles may vary widely. In various embodiments, the conductive nanoparticles have an average particle size greater than about 10 nm, greater than about 20 nm, greater than about 50 nm, greater than about 100 nm or greater than about 500 nm. In terms of upper range limits, optionally in combination with these lower range limitations, the conductive nanoparticles optionally have an average particle size less than about 1 μm, e.g., less than about 500 nm, less than about 200 nm, or less than about 100 nm. Thus, in terms of ranges, the conductive nanoparticles optionally have an average particle size ranging from about 20 nm to about 500 nm, e.g., from about 20 nm to about 100 nm, or ranging from about 5 nm to about 50 nm, e.g., from about 5 nm to about 20 nm.

If the conductive nanoparticles comprise metallic nanoparticles, the metallic nanoparticles optionally comprise one or more metals in elemental or alloy form. Thus, the metallic nanoparticles may comprise metallic nanoparticles, which comprise a metallic composition. The metallic composition preferably comprises a metal selected from the group consisting of silver, gold, copper, nickel, cobalt, palladium, platinum, indium, tin, zinc, titanium, chromium, tantalum, tungsten, iron, rhodium, iridium, ruthenium, osmium, aluminum and lead. In another aspect, the metal includes one or more transition metals as well as main group metals such as, e.g., silver, gold, copper, nickel, cobalt, palladium, platinum, indium, tin, zinc, titanium, chromium, tantalum, tungsten, iron, rhodium, iridium, ruthenium, osmium, aluminum and lead. Non-limiting examples of preferred metals for use in the present invention include silver, gold, copper, nickel, cobalt, rhodium, palladium and platinum. Silver, copper and nickel are particularly preferred metals for the purposes of the present invention, silver being particularly preferred.

The conductive phase optionally comprises a mixture of two or more different metallic nanoparticles and/or may comprise nanoparticles wherein two or more metals are present in a single nanoparticle, for example, in the form of an alloy or a mixture of these metals. Thus, the nanoparticles may comprise a metallic composition, which comprises an alloy. The alloy may comprise a solid mixture, ordered or disordered, of 2, 3, 4 or more metals. Non-limiting examples of alloys include Ag/Ni, Ag/Cu, Pt/Cu, Ru/Pt, Ir/Pt and Ag/Co. In a preferred aspect, the alloy comprises at least two metals, each of the two metals being selected from the group consisting of silver, gold, copper, nickel, cobalt, palladium, platinum, indium, tin, zinc, titanium, chromium, tantalum, tungsten, iron, rhodium, iridium, ruthenium, osmium, aluminum and lead. For example, the alloy optionally comprises a combination of metals selected from the group consisting of silver/nickel, silver/copper, silver/cobalt, platinum/copper, platinum/ruthenium, platinum/iridium, platinum/gold, palladium/gold, palladium/silver, nickel/copper, nickel/chromium, and titanium/palladium/gold.

The conductive nanoparticles optionally comprise metallic nanoparticles with a core-shell structure made of two different metals such as, e.g., a core of silver and a shell of nickel (e.g., a silver core having a diameter of about 20 nm surrounded by an about 15 nm thick nickel shell). Optionally, the nanoparticles comprise a copper, nickel, or silver core surrounded by a metal oxide shell. The metal oxide can comprise many varying metals/semimetals including, but not limited to, silicon (e.g., silica), zinc, titanium, ruthenium, nickel, iron, aluminum, etc. The size of the primary nanoparticles is from about 2 nm to about 30 nm, e.g. from about 5 nm to about 15 nm. The primary agglomerate of the primary nanoparticles having a maximum dimension of from about 50 to about 500 nm, e.g. from about 100 to about 200 nm.

In one embodiment, the resistors comprise interconnected particles having a core/shell structure, wherein either the core or shell functions as the conductive phase, and the other of the core or shell functions as the resistive phase. In a preferred aspect, the shell comprises a material selected from the group consisting of: silica, titania, and alumina. In this aspect, the shell preferably acts as the resistive phase. The shell is preferably from about 0.1 to about 5 nm, e.g. from about 0.5 to about 3 nm. In a preferred embodiment, the core comprises a material selected from the group consisting of silver, nickel, copper, NiCr, carbon black, and a metal oxide (e.g., a ruthenate such as RuO₂). Desirably, the shell, e.g., silica shell, can be functionalized with functional groups, including, but not limited to acrylate groups, perfluoro groups, alcohol groups, epoxide groups, aliphatic alkane groups, etc. One advantage of functionalizing the surface of the core-shell particles is that the particles are more easily dispersed in a variety of vehicles. In addition, functionalization of the surface of the particles, in some cases, allows for polymerization of certain functional groups (e.g., acrylate groups) on the surface of the particles. The shell of the core-shell particles optionally may form all or a portion of the resistive phase of the resistor during processing. In a preferred embodiment, the shells of adjacent particles connect to one another and facilitate the flow of electrons from core to core through electron tunneling effects. In this embodiment, the resistor comprises interconnected particles having core/shell structures, wherein the cores comprise the conductive phase and the shells comprise the resistive phase. In an alternative embodiment, the resistor comprises interconnected particles having core/shell structures, wherein the cores comprise the resistive phase and the shells comprise the conductive phase.

Optionally, the cores of adjacent particles may be fused chemically by adding a base to the particles after their deposition. The base (e.g., sodium hydroxide, potassium hydroxide or ammonium hydroxide, preferably at pH of about 10) preferably dissolves all or a portion of the shell to expose the surface of the cores. The exposed cores are then heated, e.g., to about 150° C., to fuse the cores together. This approach may be employed, for example, to form low ohm resistors if the cores are highly conductive. Alternatively, this process may be employed to form mid or high ohm resistors if the cores comprise resistive particles, e.g., resistive nanoparticles, examples of which are provided below.

In one embodiment, the conductive nanoparticles forming the conductive phase are only moderately conductive, defined herein as having a resistivity less than about 1,000,000 μΩ-cm. In one embodiment, for example, the conductive particles, e.g., conductive nanoparticles, comprise carbon, e.g., as carbon black or modified carbon black. Although carbon is only moderately conductive, the conductive phase (as well as the conductive phase formed therefrom) may comprise carbon if the resistive phase has a resistivity greater than carbon (for example, in a high ohm resistor). In various embodiments, the resistor comprises carbon in an amount greater than about 50 wt. %, e.g., greater than about 65 wt. % or greater than about 80 wt. %, based on the total weight of the resistor. The conductive phase of the resistor optionally comprises carbon in an amount greater than about 50 wt. %, e.g., greater than about 75 wt. % or greater than about 90 wt. %, based on the total weight of the conductive phase.

In other high ohm resistor embodiments, the conductive phase precursor comprises conductive particles, e.g., conductive nanoparticle, comprising one or more of the following: metal rutile, pyrochlore, or perovskite phase compounds, many of which contain ruthenium. Examples include RuO₂, Pb₂Ru₂O₇₋ₓ, (where x is 0 to 1), or SrRuO₃. Other metallic oxides that behave similarly to these ruthenates may be used in the conductive nanoparticles. Substitutions for Ru can include Ir, Rh or Os. La and Ta compounds can also be used. Like carbon, although these materials are only moderately conductive, the conductive phase may comprise one or more of these materials if the resistive phase formed from the resistive phase precursor, discussed below, has a greater resistivity.

In another embodiment, the metallic nanoparticles comprise a conducting metal oxide. A non-limiting list of exemplary conducting metal oxides that may be included in the metallic nanoparticles includes: ruthenium oxide, strontium ruthenate, indium tin oxide, antimony tin oxide, zinc oxide, and zirconium tin oxide.

Similarly, the conductive nanoparticles optionally comprise a metal ruthenate, a compound having the formula MₓRu_{y}O_{z}, wherein M is a metal selected from the group consisting of: Bi, Ir, Pb, Ti, La, Sr, Ca, Ba, and Cu. Other materials for possible inclusion in the conductive nanoparticles, include zinc oxide, indium oxide, metal nitrides that semiconduct, TiN, ITO, ATO, zirconium tin oxide and conductive glasses.

The resistive phase preferably comprises resistive particles that exhibit a high bulk resistivity (in the absence of the conductive phase) such as, e.g., a bulk resistivity of greater than about 5,000 μΩ-cm, e.g., greater than about 10,000 μΩ-cm, greater than about 50,000 μΩ-cm, greater than about 100,000 μΩ-cm, greater than about 1,000,000 μΩ-cm or greater than about 10,000,000 μΩ-cm. The resistive phase optionally comprises insulator particles, defined herein as particles exhibiting a resistivity greater than about 100 Ω-cm, e.g., greater than about 1,000 Ω-cm or greater than about 1,000,000 Ω-cm or higher, or a resistivity of up to 10¹² Ω-cm.

The resistive particles optionally are moderately conductive. In one embodiment, for example, the resistive particles, e.g., resistive nanoparticles, comprise carbon, e.g., as carbon black or modified carbon black. Although carbon is moderately conductive, the resistive phase precursor (as well as the resistive phase formed therefrom) may comprise carbon if the conductive phase formed from the conductive phase precursor, discussed above, is more conductive than carbon.

In other embodiments, the resistive particles, e.g., resistive nanoparticles, comprise one or more of the following: metal rutile, pyrochlore, or perovskite phase compounds, many of which contain ruthenium. Examples include RuO₂, Pb₂Ru₂O₇₋ₓ, (where x is 0 to 1), or SrRuO₃. Other metallic oxides that behave similarly to these ruthenates may be used in the resistive particles, e.g., as resistive nanoparticles. Substitutions for Ru can include Ir, Rh or Os. La and Ta compounds can also be used. Like carbon, although these materials are moderately conductive, the resistive particles may comprise one or more of these materials if the conductive phase, discussed above, has a greater conductivity. Similarly, the resistive particles, preferably resistive nanoparticles, optionally comprise a metal ruthenate, a compound having the formula MₓRu_{y}O_{z}, wherein M is a metal selected from the group consisting of: Bi, Ir, Pb, Ti, La, Sr, Ca, Ba, and Cu. Other materials for possible inclusion in the resistive particles, preferably resistive nanoparticles, include zinc oxide, indium oxide, metal nitrides that semiconduct, TiN, nickel oxide (NiO), NiCr alloy, ITO, and other conductive glasses.

In one preferred embodiment, the resistive particles comprise insulator particles, e.g., insulator nanoparticles. A non-limiting list of various types of insulator particles includes silica particles, alumina particles, titania particles, borosilicate glass particles, lead borosilicate glass particles, and lead free glass particles. Thus, the insulator particles, e.g., insulator nanoparticles, optionally are selected from the group consisting of silica particles, alumina particles, titania particles, borosilicate glass particles, lead borosilicate glass particles, and lead free glass particles.

In another embodiment, the resistive phase comprises an insulator matrix. The insulator matrix optionally is formed from a prepolymer or preglass. Non-limiting examples of preglasses include, but are not limited to, alkali salt silicates and spin on glass (SOG). Non-limiting examples of prepolymers include, but are not limited to acrylates, methacrylates, epoxides, etc. When exposed to certain conditions (e.g., UV radiation) the prepolymer, for example, polymerizes to form a polymer insulator matrix. In one embodiment, the insulator matrix comprises insulator particles dispersed therewithin. In another embodiment, the insulator matrix is free of or substantially free of insulator particles.

In one embodiment, the resistive particles, e.g., resistive nanoparticles, comprise glass, preferably low-melting glass. As used herein, “low-melting” glass means glass that has a softening point below about 500° C., e.g., below about 400° C., or below about 300° C. The glass preferably comprises a silicate. For example, the silicate optionally comprises a borosilicate, e.g., a lead borosilicate or a borosilicate comprising one or more of aluminum, zinc, silver, copper, indium, barium and/or strontium.

Methods used for the preparation of resistive particles, e.g., resistive nanoparticles, comprising glass may be found, for example, in U.S. patent application Ser. No. 11/335,727, filed Jan. 20, 2006, entitled “Method of Making Nanoparticulates and Use of the Nanoparticulates to Make Products Using a Flame Reactor,” the entirety of which is incorporated by reference herein.

The size of the resistive particles may vary widely. In one embodiment, the resistive particles have an average particle size (based on each particle's largest dimension) greater than about 1 μm, e.g., greater than about 5 μm, greater than about 10 μm or greater than about 100 μm. In terms of ranges, the resistive particles optionally have an average particle size of from about 1 μm to about 100 μm, e.g., from about 1 μm to about 100 μm. In another embodiment, the resistive particles have an average particle size greater than about 10 nm, greater than about 20 nm, greater than about 50 nm, greater than about 100 nm or greater than about 500 nm. In terms of upper range limits, optionally in combination with these lower range limitations, the resistive particles optionally have an average particle size less than about 1 μm, e.g., less than about 500 nm, less than about 200 nm, or less than about 100 nm. In another aspect, the resistive particles, e.g., resistive nanoparticles, may have an average particle size (number average) of at least about 10 nm, e.g., at least about 20 nm, or at least about 30 nm, but preferably not higher than about 80 nm, e.g., not higher than about 70 nm, not higher than about 60 nm, or not higher than about 50 nm. For example, the resistive particles may have an average particle size in the range of from about 25 nm to about 75 nm.

Morphology of resistive nanoparticles can be spherical or cubic in shape. In one possible embodiment the resistive nanoparticles comprise agglomerates of spherical nanoparticles that can be termed “fractal-like” or in some instances resemble “strings of pearls”.

Many possible combinations of conductive nanoparticles and resistive particles may be employed in the resistor in order to provide the desired electrical characteristics. A few non-limiting combinations of conductive nanoparticles and resistive particles that may be employed in the resistor of the present invention are provided below in Table 1.

TABLE 1
EXEMPLARY CONDUCTIVE NANOPARTICLE/
RESISTIVE PARTICLE COMBINATIONS

| CONDUCTIVE | RESISTIVE |
|---|---|
| NANOPARTICLES | PARTICLES |
| Metal Nanoparticles | Modified Carbon Black |
| Metal Nanoparticles | Insulator Particles |
| Metal Nanoparticles | Metal Ruthenates |
| Modified Carbon Black | Insulator Particles |
| Modified Carbon Black | Metal Oxides |
| Modified Carbon Black | Metal Ruthenates |
| Metal Oxides | Modified Carbon Black |
| Metal Oxides | Insulator Particles |
| Conductive Glasses | Insulator Particles |
| Metal Ruthenates | Insulator Particles |

Depending on how the resistor is formed, the conductive nanoparticles, e.g., metallic nanoparticles, in the conductive phase of the resistor optionally exhibit some degree of sintering or “necking” with adjacent metallic nanoparticles. Generally, increased necking between adjacent metallic nanoparticles increases the conductivity (reducing resisitivity) of the resistor. Preferably, a majority (optionally at least about 10%, at least about 20% or at least about 30%) of the conductive nanoparticles are fused to at least one adjacent conductive nanoparticle and/or to at least one adjacent resistive particle. Sintering and necking are further described in U.S. patent application Ser. No. 11/331,231, filed Jan. 13, 2006, entitled “Printable Electronic Conductors,” the entirety of which is incorporated by reference herein.

Generally, resistive particles do not exhibit the degree of necking or sintering obtainable with metallic particles, e.g., metallic nanoparticles. Preferably, the resistive particles are positioned such that they exhibit tunneling with adjacent particles (e.g., adjacent conductive nanoparticles and/or adjacent resistive particles). Some types of resistive particles, however, may have the ability to sinter or neck with adjacent particles. In addition, some resistive particles can form resistive matrices when the resistive particles undergo polymerization or gelling. In this case, the resistive particles will be chemically bonded adjacent particles. Optionally, at least about 10%, at least about 20%, at least about 30%, at least about 40% or at least a majority of the resistive particles are fused to at least one adjacent resistive particle and/or to at least one adjacent conductive nanoparticle.

In one embodiment, the resistor further comprises a fusing material (e.g., formed from a metal precursor), which adheres or secures (and preferably electrically interconnects) the conductive phase (e.g., conductive particles) to the resistive phase (e.g., resistive particles). The fusing material optionally is selected from the group consisting of: PEDOT, or a metal (e.g., Ni, Ag, Ru) formed from a metal precursor (e.g., silver neodecanoate, silver acetate, nickel acetate, ruthenium oxide, ruthenium acetate). The fusing material also preferably adheres or secures, at least to some extent, conductive particles, e.g., metallic nanoparticles, to adjacent conductive particles. Similarly, the fusing material optionally adheres and secures, at least to some extent, resistive particles to adjacent resistive particles. Preferably, the fusing material is electrically conductive so as to facilitate the flow of electrons through the conductive phase and resistive phase, although the presence of the resistive phase should limit the conductivity of the overall feature so that it acts as a resistor.

In a related embodiment, the resistive phase comprises or consists essentially of the fusing material and the conductive phase comprises conductive particles, e.g., conductive nanoparticles. In this embodiment, the fusing material has a conductivity less than the conductivity of the conductive nanoparticles and connects adjacent conductive nanoparticles to one another. In this embodiment, the resistor may or may not comprise resistive particles, e.g., resistive nanoparticles.

In another embodiment, the resistive phase comprises resistive particles, e.g., resistive nanoparticles, and the conductive phase comprises or consists essentially of the fusing material. In this embodiment, the fusing material has a conductivity greater than the conductivity of the resistive particles and connects adjacent resistive particles to one another. In this embodiment, the resistor may or may not comprise conductive particles, e.g., conductive nanoparticles. In this embodiment, the resistive particles optionally comprise resistive nanoparticles, which may be selected from the group consisting of glass nanoparticles, modified carbon black, a metal ruthenate and insulator nanoparticles (optionally selected from the group consisting of silica particles, alumina particles, titania particles, borosilicate glass particles, lead borosilicate glass particles, and lead free glass particles).

In still another embodiment, the resistor comprises a single resistive phase and no separate conductive phase. In this embodiment, the resistor preferably comprises resistive particles of a first material, e.g., RuO₂, which particles are connected to adjacent resistive particles by a fusing material that also comprises the first material. For example, the resistor optionally comprises a network of RuO₂ particles that are connected to one another by a fusing material that also comprises RuO₂ and which may be formed from a ruthenium oxide precursor, e.g., a ruthenium amide, a ruthenium ester, a ruthenium carboxylate salt or a ruthenium acetylacetonate, e.g., ruthenium-2,4-pentanedianate. In this embodiment, the resistive particles and the fusing agent used to form the fusing material may be delivered in the same or different inks from one another.

The resistivity of the resistors of the present invention may vary widely depending, for example, on the types of conductive and resistive phases used to form the resistor, the respective amounts of the conductive and resistive phases used to form the resistor and the morphology of the conductive and resistive phases used to form the resistor. Generally, the greater the volume ratio of conductive phase to resistive phase in the resistor, the more conductive (less resistive) the resistor will be. Conversely, the less the volume ratio of the conductive phase to the resistive phase in the resistor, the less conductive (more resistive) the resistor will be. In various embodiments, the volume ratio of the conductive phase to the resistive phase in the resistor is greater than about 60, e.g., greater than about 65, greater than about 70, greater than about 75, greater than about 80, greater than about 85, or greater than about 90. In terms of upper range limitations, optionally in combination with these lower range limitations, the volume ratio of the conductive phase to the resistive phase in the resistor optionally is less than about 50, less than about 30, less than about 25, less than about 15, less than about 10, or less than about 5.

In one aspect, the average thickness of the resistor may be greater than about 0.01 μm, e.g., greater than about 0.05 μm, greater than about 0.1 μm, or greater than about 0.5 μm. The thickness can even be greater than about 1 μm, such as greater than about 5 μm. Additionally, the average thickness of the resistor optionally is less than about 50 μm, e.g., less than about 10 μm, less than about 5 μm, or less than about 1 μm. These thicknesses can be obtained by ink-jet deposition or deposition of discrete units of material in a single pass or in two or more passes. For example, a single layer can be deposited and dried, followed by one or more repetitions of this cycle, if desired.

In various embodiments, the resistivity of the resistors of the present invention may be greater than about 1,000 μΩ-cm, e.g., greater than about 10,000 μΩ-cm, greater than about 100,000 μΩ-cm or greater than about 1,000,000 μΩ-cm. Of course, to constitute a “resistor,” the electronic features of the present invention must exhibit some degree of resistivity. As used herein, a “resistor” has a resistivity greater than about 100 μΩ-cm. In terms of ranges, the resistors of the present invention optionally have a resistivity ranging from about 100,000 to about 1,000,000, e.g., from about 1,000,000 to about 10,000,000, from about 100,000,000 to about 1,000,000,000, from about 10,000,000,000 to about 100,000,000,000 or from about 100,000,000,000 to about 1,000,000,000,000 μΩ-cm or greater.

Depending on their desired uses, the resistors of the invention may be low-ohm, mid-ohm or high-ohm resistors. As used herein, a low-ohm resistor has a resistance of not greater than about 10 Ω/square, such as from about 0.2 to about 100 Ω/square. A mid-ohm resistor has a resistance of from about to about 10 Ω/square to about 10,000 Ω/square and a high-ohm resistor has a resistivity of at least about 10,000 Ω/square. Table 2 illustrates the conversion of material resistivity to resistance for different feature thicknesses.

TABLE 2
CONVERSION OF SHEET RESISTANCE

| | Resistivity (μΩ * cm) | | |
|---|---|---|---|
| Sheet Resistance | 2 μm thickness | 4 μm thickness | 6 μm thickness |
| 1 Ω/square | 200 | 400 | 600 |
| 100 Ω/square | 20,000 | 40,000 | 60,000 |
| 10,000 Ω/square | 2 × 10⁶ | 4 × 10⁶ | 6 × 10⁶ |
| 1,000,000 Ω/square | 2 × 10⁸ | 4 × 10⁸ | 6 × 10⁸ |

The resistor preferably is porous. In one aspect, at least a portion of the pores or voids in the resistor are at least partially filled with the resistive phase, e.g., resistive particles, preferably resistive nanoparticles. In another aspect, at least a portion of the pores or voids are at least partially filled with an organic material, e.g., an organic polymer such as polyvinylpyrrolidone. The polymer preferably comprises units of a monomer, which comprises at least one heteroatom selected from O and N. For example, the polymer optionally comprises units of a monomer which comprises one or more of a hydroxyl group, a carbonyl group, an ether group, an amido group, a carboxyl group, an imido group and an amino group. In another aspect, the polymer comprises units of at least one monomer which comprises a structural element selected from —COO—, —O—CO—O—, —C—O—C—, —CO—O—CO—, —CONR—, —NR—CO—O—, —NR¹—CO—NR²—, —CO—NR—CO—, —SO₂—NR— and —SO₂—O—, wherein R, R¹ and R² independently represent hydrogen or an organic radical.

As mentioned above, the resistors of the present invention optionally have a network of pores defined by the network of interconnected nodes, each node being formed from a respective conductive nanoparticle or resistive particle. The network of pores may be characterized by the average distance between adjacent pores, the pore size distribution, volume percent of all pores based on the volume of entire resistor, and the average pore volume (of the individual pores), described below. In another embodiment, the resistor comprises a network of “voids” defined by the spaces between the metallic nanoparticles and the resistive particles. The resistor of the present invention optionally has an average pore or void volume of less than about 10,000,000 nm³, e.g., less than about 1,000,000 nm³ or less than about 100,000 nm³. In various other aspects, the pore or void volume is less than about 50,000 nm³, e.g., less than about 20,000 nm³ or less than about 10,000 nm³. In general, the greater the pore/void volume, the more resistive the resistor will be.

The average distance between adjacent pores in the resistor may be determined by, for example, stroboscopic image capture and image analysis on the nanometer scale length. Alternatively, SEM or TEM may be used to determine the average distance between adjacent pores. In various aspects of the present invention, the average distance between adjacent pores in the resistor is from about 0.5 nm to about 500 μm, e.g., from about 1 μm to about 500 μm, from about 1 nm to about 250 nm, from about 1 to about 100 nm or from about 1 to about 50 nm. It is preferred for the porosity to be evenly distributed so as to reduce unwanted mechanical and physical properties of the resistor.

Additionally, the pore or void network may be described in terms of the total pore/void volume, based on the volume of the resistor as a whole. In various aspects, the resistor comprises the pores or voids in an amount less than about 50 volume percent, e.g., less than about 25 volume percent, less than about 15 volume percent, less than about 10 volume percent or less than about 5 volume percent, based on the total volume of the resistor.

Further, the pores or voids may be characterized as having an ordered arrangement or a disordered (random) arrangement within the resistor. By “ordered arrangement” it is meant that the pores or voids are arranged in the resistor in some repeating pattern. By “disordered arrangement” or “random arrangement” it is meant that the pores or voids are arranged substantially randomly within the resistor.

The resistor optionally has a temperature coefficient of resistance (TCR) of less than 10,000 ppm/° C., e.g., less than about 1,000 ppm/° C. or less than about 100 ppm/° C.

The tolerance of the resistor is optionally less than about 25%, less than about 10%, less than about 5%, less than about 2% or less than about 1%.

The resistor optionally has a minimum feature size of not greater than about 250 μm, such as not greater than about 100 μm, and even not greater than about 50 μm, such as not greater than about 25 μm, or not greater than about 10 μm. These resistors can be deposited by ink-jet printing of a single droplet or multiple droplets at the same location with or without drying in between deposition of droplets or periods of multiple droplet deposition.

The compositions and methods of the present invention can also be used to form resistors in the form of lines. In one aspect, the lines can advantageously have an average width of not greater than about 250 μm, such as not greater than about 200 μm, not greater than about 150 μm, not greater than about 100 μm, or not greater than about 50 μm. The resistors may be embedded or surface mounted.

The resistors of the present invention may be incorporated in many different types of applications. A non-limiting list of possible applications includes: sensors (e.g., for humidity and various liquids and gases), RF ID antennas and tags, thermistors, varistors, strain gauge resistors, digitally printed multi-layer circuit boards, printed membrane keyboards, smart packages, security documents, “disposable electronics” printed on plastics or paper stock, interconnects for applications in printed logic, passive matrix displays, and active matrix backplanes for applications such as OLED displays and thin film transistors (TFT) AMLCD technology, field-effect transistors (FETs), and in flat panel displays such as plasma display panels. Other possible applications are described in U.S. patent application Ser. No. 11/331,231, filed Jan. 13, 2006, previously incorporated by reference herein.

### II. Processes for Forming Resistors

As discussed in greater detail below, the resistors of the present invention preferably are formed by any of the processes of the present invention. It is contemplated, however, that the resistors of the present invention may also be formed by other heretofore unknown processes, and the present invention is not limited to resistors formed by the processes of the present invention unless expressly so claimed herein.

The processes of the invention for forming resistors may be broken down into two main groups: (1) processes for forming a resistor from a single ink (e.g., where a single ink provides elements for forming both the conductive phase and the resistive phase of the resistor); and (2) processes for forming a resistor from two or more inks (e.g., where one ink provides an element for forming the conductive phase and a separate ink provides an element for forming the resistive phase).

In the first embodiment, the process comprises the steps of: (a) providing an ink comprising a conductive phase precursor, a resistive phase precursor and a vehicle; (b) depositing the ink on a substrate; (c) removing a majority of the vehicle from the deposited ink; (d) converting the conductive phase precursor to a conductive phase (optionally during step (c)); and (e) converting the resistive phase precursor to a resistive phase (optionally during step (c)). In this aspect, additional inks may be used to modify the structure of the resistor (e.g., provide a protective coating) or to facilitate conversion of the conductive phase precursor to the conductive phase or the resistive phase precursor to the resistive phase, so long as one ink comprising both a conductive phase precursor and a resistive phase precursor is deposited on a substrate to form a resistor.

In the second embodiment, the resistor of the present invention is formed by a process comprising the steps of: (a) providing a first ink comprising a conductive phase precursor and a first vehicle; (b) providing a second ink comprising a resistive phase precursor and a second vehicle; (c) depositing the first ink and the second ink on a substrate; (d) removing a majority of the first vehicle and a majority of the second vehicle from the deposited first and second inks; (e) converting the conductive phase precursor to a conductive phase (optionally during step (d)); and (f) converting the resistive phase precursor to a resistive phase (optionally during step (d)). Steps (d), (e) and (f) optionally occur at least partially simultaneously. Step (d) optionally comprises heating and/or curing the deposited first and second inks under conditions effective to remove the majority of the first and second vehicles. Step (d) also may cause adjacent conductive particles, formed from the conductive phase precursor, and/or adjacent resistive phase particles, formed from the resistive precursor, to sinter to one another during formation of the resistor. In a related embodiment, more than two inks are used to form the resistor.

A. Ink Formulations for Forming Printable Resistors from a Single Ink

As indicated above, in some aspects, the invention is to processes for forming resistors from a single ink comprising both a conductive phase precursor and a resistive phase precursor. In this context, the term “single” means that a weight majority of the conductive phase and a weight majority of the resistive phase in the resistor are derived from the same ink. That is, the use of the term “single” in this context does not preclude the use of more than one ink, so long as only one ink provides a weight majority of the conductive phase and a weight majority of the resistive phase in the ultimately-formed resistor. Additional inks may be employed, for example, to: (1) provide a protective coating for the resistor; (2) facilitate conversion of the conductive phase precursor to the conductive phase (for example, with a reducing agent); (3) facilitate conversion of the resistive phase precursor to the resistive phase (for example, with an oxidizing agent); or (4) to electrically connect the resistive phase to the conductive phase (for example, with a fusing agent).

The ink used in the single-ink process for forming resistors of the invention comprises a conductive phase precursor, a resistive phase precursor and a vehicle for imparting flowability to the ink. The ink may comprise one or more additional components such as, but not limited to, additives such as adhesion promoters, rheology modifiers, surfactants, wetting angle modifiers, humectants, crystallization inhibitors, binders (e.g., fusing agents), dyes/pigments, and the like.

In the single ink formulations (i.e., where the resistor is formed from a single ink comprising both a conductive phase precursor and a resistive phase precursor), there are many possible combinations of conductive phase precursors and resistive phase precursors that may be utilized to provide a resistive having the desired electrical characteristics. A few non-limiting combinations of conductive phase precursors and resistive phase precursors that may be employed in the single ink according to this aspect of the invention is provided below in Table 3.

TABLE 3
VARIOUS CONDUCTIVE PHASE PRECURSOR/RESISTIVE PHASE
PRECURSOR COMBINATIONS FOR SINGLE INK FORMULATIONS

| CONDUCTIVE PHASE | RESISTIVE PHASE |
|---|---|
| PRECURSOR | PRECURSOR |
| Metal Precursor | Modified Carbon Black |
| Metal Nanoparticles | Modified Carbon Black |
| Metal Precursor | Modified Carbon Black |
| Metal Precursor | Modified Carbon Black & |
| | Reducing Agent |
| Metal Precursor | Insulator Particles |
| Metal Precursor | Insulator Particles |
| Metal Precursor | Insulator Particles & |
| | Reducing Agent |
| Metal Nanoparticles | Insulator Particles |
| Metal Nanoparticles | Metal Ruthenate Particles |
| Modified Carbon Black | Insulator Particles |
| Modified Carbon Black | Metal Oxide Particles |
| Modified Carbon Black | Metal Ruthenates |
| Metal Oxide Particles | Modified Carbon Black |
| Metal Oxide Particles | Insulator Particles |
| Conductive Glass Particles | Insulator Particles |
| Metal Ruthenate Particles | Insulator Particles |
| Metal Nanoparticles | Insulator Matrix |

The formulation of the ink will depend largely on the substrate on which the ink is intended to be deposited and the tolerance of that substrate to high temperatures and pressures. Generally, low cost electronics and traditional printed circuit boards are printed largely on paper and polymer substrates. The temperature tolerance of these materials is generally less than about 150° C. with the exception of short duration exposure to higher temperatures (e.g., during lamination or wave soldering, for example). The second type of substrate comprises glass plates used, for example, in displays. These types of substrates are generally amenable to processing in the 300° C. to 550° C. range. The third type of substrate includes ceramic substrates, which permit processing at temperatures up to 800° C. and higher. The formulation chemistry and choice of conductive phase precursor and resistive phase precursor for this invention will be impacted by the target substrate material/product. Sintering of micro particles and glass frit materials, for example, may be possible on the ceramic substrates while more reactive precursors preferably are employed for the low temperature substrates.

1. Conductive Phase Precursors

As described above, the ink used to form the resistors comprises a conductive phase precursor. As used herein, the term “conductive phase precursor” means a composition suitable for inclusion in an ink, e.g., a direct write ink (such as a piezo-electric or thermal ink jet ink), preferably a digital ink, and which is capable of forming the conductive phase in a resistor formed from the ink, e.g., through a direct write printing process (such as piezo or thermal ink jet printing) or a digital printing process. The conductive phase precursor preferably comprises conductive nanoparticles (e.g., metallic nanoparticles) or a metal precursor. As used herein, “conductive nanoparticles” means metallic or non-metallic nanoparticles capable of forming a conductive phase in a printed resistor, the conductive phase having a resistivity less than a resistive phase in the resistor. The term “metallic nanoparticles” means nanoparticles comprising one or more metals in elemental or alloy form. “Metal precursor” means a compound comprising a metal and capable of being converted, optionally through a reaction with a reducing agent and optionally with the application of heat, to form an elemental metal corresponding to the metal in the metal precursor. “Elemental metal” means a substantially pure metal or alloy having an oxidation state of 0.

The conductive particles may be only moderately conductive (e.g., less than 10 MΩ-cm). In one embodiment, for example, the conductive particles, e.g., conductive nanoparticles, comprise carbon, e.g., as carbon black or modified carbon black. Although carbon is only moderately conductive, the conductive phase precursor (as well as the conductive phase formed therefrom) may comprise carbon if the resistive phase formed from the resistive phase precursor, discussed below, has a resistivity greater than carbon. Processes for forming carbon black and incorporating carbon black in inks are well known and are described, for example, in U.S. Pat. Nos. 2,785,964; 3,401,020; 3,922,355; 4,370,308; 4,879,104; 5,281,261; 5,571,311; 5,747,562; 6,156,837; 6,169,129; 6,548,036 and 6,827,772, and Reissue No. 28,972, the entireties of which are incorporated herein by reference.

In other embodiments, the conductive phase precursor comprises a conductive particle, e.g., conductive nanoparticle, comprising one or more of the following: metal rutile, pyrochlore, or perovskite phase compounds, many of which contain ruthenium. Examples include RuO₂, Pb₂Ru₂O₇₋ₓ (where x is 0 to 1), or SrRuO₃. Other metallic oxides that behave similarly to these ruthenates may be used in the conductive phase precursor, e.g., as conductive particles, preferably conductive nanoparticles. Substitutions for Ru can include Ir, Rh or Os. La and Ta compounds can also be used. Like carbon, although these materials are only moderately conductive, the conductive phase precursor (as well as the conductive phase formed therefrom) may comprise one or more of these materials if the resistive phase formed from the resistive phase precursor, discussed below, has a greater resistivity.

Similarly, the conductive phase precursor (e.g., as conductive particles, preferably conductive nanoparticles) optionally comprises a metal ruthenate, a compound having the formula MₓRu_{y}O_{z}, wherein M is a metal selected from the group consisting of: Bi, Ir, Pb, Ti, La, Sr, Ca, Ba, and Cu. Other materials for possible inclusion in the conductive phase precursor, e.g., as conductive particles, preferably conductive nanoparticles, include zinc oxide, indium oxide, metal nitrides that semiconduct, TiN, nickel, nickel oxide (NiO), NiCr, ITO, and conductive glasses.

The conductive phase precursor optionally comprises metallic nanoparticles, which comprise a metallic composition (examples of which are fully provided above with reference to the resistors of the present invention). In another embodiment, the metallic nanoparticles comprise a conducting metal oxide, examples of which are also provided above. In yet another aspect, the metallic nanoparticles have a core-shell structure made of two different metals. The various possible compositions and properties of the nanoparticles are fully described above.

Metallic nanoparticles suitable for use in the ink to form the resistors of the present invention can be produced by a number of methods. For example, metallic nanoparticles may be formed by spray pyrolysis, as described, for example, in U.S. Provisional Patent Application No. 60/645,985, filed Jan. 21, 2005, or in an organic matrix, as described in U.S. patent application Ser. No. 11/117,701, filed Apr. 29, 2005, the entireties of which are fully incorporated herein by reference. A non-limiting example of one preferred method of making metallic nanoparticles is known as the polyol process and is disclosed in U.S. Pat. No. 4,539,041, which is fully incorporated herein by reference. A modification of this method is described in, e.g., P.-Y. Silvert et al., “Preparation of colloidal silver dispersions by the polyol process” Part 1—Synthesis and characterization, J. Mater. Chem., 1996, 6(4), 573-577; Part 2—Mechanism of particle formation, J. Mater. Chem., 1997, 7(2), 293-299. The entire disclosures of these documents are expressly incorporated by reference herein. Briefly, in the polyol process a metal compound is dissolved in, and reduced by a polyol such as, e.g., a glycol at elevated temperature to afford corresponding metal particles. In the modified polyol process the reduction is carried out in the presence of a dissolved polymer, i.e., polyvinylpyrrolidone.

A particularly preferred modification of the polyol process for producing metallic nanoparticles which carry a capping agent such as polyvinylpyrrolidone thereon is described in U.S. Provisional Patent Application Ser. Nos. 60/643,577 filed Jan. 14, 2005, 60/643,629 filed Jan. 14, 2005, and 60/643,578 filed Jan. 14, 2005, the entireties of which are incorporated herein by reference, and in co-pending Non-Provisional U.S. patent application Ser. Nos. 11/331,211 filed Jan. 13, 2006, Ser. No. 11/331,238 filed Jan. 13, 2006, and Ser. No. 11/331,230 filed Jan. 13, 2006, which are also fully incorporated by reference herein. In a preferred aspect of this modified process, a dissolved metal compound (e.g., a silver compound such as silver nitrate) is combined with and reduced by a polyol (e.g., ethylene glycol, propylene glycol and the like) at an elevated temperature (e.g., at about 120° C.) and in the presence of a heteroatom containing polymer (e.g., polyvinylpyrrolidone) which serves as the capping agent.

In one embodiment, the conductive phase comprises composite conductive particles, e.g., composite conductive nanoparticles, meaning particles comprising a conductive portion and an insulative portion. The conductive portion may be selected form any of the compositions described above for possible inclusion in the conductive particles, e.g., metals, metal oxides, metal nitrides, carbon, etc. The insulative portion of the composite particles preferably is selected from the group consisting of a glass, a polymer and a metal oxide. Composite particles may be formed, for example, through spray pyrolysis of flame spray pyrolysis, which are described in co-pending U.S. patent application Ser. Nos. 11/335,729, filed Jan. 20, 2006, Ser. No. 11/335,726, filed Jan. 20, 2006, and Ser. No. 11/335,685, filed Jan. 20, 2006, the entireties of which are incorporated herein by reference.

If the conductive phase precursor comprises metallic nanoparticles, the metallic nanoparticles (at least while in the ink) preferably comprise a capping agent, e.g., disposed on a surface of the metallic nanoparticles. In a preferred aspect, a capping agent is present on the metallic nanoparticles, at least while in ink form, to inhibit substantial agglomeration of the nanoparticles. Due to their small size and the high surface energies associated therewith, nanoparticles usually show a strong tendency to agglomerate and form larger secondary particles (agglomerates). The capping agent shields (e.g., sterically and/or through charge effects) the nanoparticles from each other to at least some extent and thereby substantially prevents a direct contact between individual nanoparticles. The capping agent does not have to be present as a continuous coating (shell) on the entire surface of the metallic nanoparticles. Rather, in order to prevent substantial agglomeration of the nanoparticles it will often be sufficient for the capping agent to be present on only a part of the surface of the metallic nanoparticles.

In another aspect, the capping agent serves to change the resistance of the conductive particles, e.g., metallic nanoparticles, (optionally in addition to improving particle dispersibility), and, ultimately, of the conductive phase formed in the resistor from the conductive particles. Such surface modifications may be obtained, for example, by attaching a reactive metal-containing species or attaching a non-metal-containing species to the surface of the conductive particles. The resistivity of the conductive particles, e.g., metallic nanoparticles, may be controlled, for example, by controlling the thickness of the capping agent on the conductive particles. By controlling the thickness of the capping agent on the conductive particles, the resistivity of the conductive particles, can be carefully “tuned”. Thus, in one embodiment, the resistance of the resistors formed form the inks of the present invention may be controlled primarily by type and thickness of the capping agent of the conductive particles rather than by spacing between particles or limiting contact between the conductive phase and the resistive phase.

Particularly preferred capping agents comprise one or two O and/or N atoms (per monomer unit in the case of a polymer). The atoms with a lone electron pair will usually be present in the substance in the form of a functional group such as, e.g., a hydroxy group, a carbonyl group, an ether group, an amido group, a carboxylic group, and an amino group, or as a constituent of a functional group that comprises one or more of these groups as a structural element thereof. Non-limiting examples of functional groups include —COO—, —O—CO—O—, —CO—O—CO—, —C—O—C—, —CONR—, —NR—CO—O—, —NR¹—CO—NR²—, —CO—NR—CO—, —SO₂—NR— and —SO₂—O—, wherein R, R¹ and R² independently represent hydrogen or an organic radical (e.g., an aliphatic or aromatic, unsubstituted or substituted radical comprising from about 1 to about 20 carbon atoms). Such functional groups may comprise the above (and other) structural elements as part of a cyclic structure (e.g., in the form of a cyclic ester, amide, anhydride, imide, carbonate, urethane, urea, and the like). Optionally, the capping agent comprises polyvinylpyrrolidone (PVP). In the case of PVP, the preferred weight average molecular weight is in the range of from about 3,000 to about 60,000 and a particularly preferred average molecular weight is about 10,000. Capping agents are further described in U.S. patent application Ser. No. 11/331,231, filed Jan. 13, 2006, previously incorporated by reference herein.

According to a preferred aspect of the present invention, the conductive phase precursor comprises conductive particles, e.g., conductive nanoparticles whether metallic or non-metallic, exhibiting a narrow particle size distribution. A narrow particle size distribution is particularly advantageous for direct-write printing applications because it results in a reduced clogging of the orifice of a direct-write device by large particles and provides the ability to form features having a fine line width, high resolution and acceptable packing density.

The conductive particles, e.g., conductive nanoparticles whether metallic or non-metallic, optionally used in the inks of the present invention preferably also show a high degree of uniformity in shape. Preferably, the conductive particles are substantially spherical in shape. In a preferred aspect of the present invention, at least about 90%, e.g., at least about 95%, or at least about 99% of the conductive particles comprised in the ink are substantially spherical in shape. In another preferred aspect, the ink is substantially free of particles in the form of flakes.

In yet another preferred aspect, the conductive particles, e.g., conductive nanoparticles whether metallic or non-metallic, are substantially free of micron-size particles, i.e., particles having a size of about 1 micron or above. Even more preferably, the conductive particles may be substantially free of particles having a size (=largest dimension, e.g., diameter in the case of substantially spherical particles) of more than about 500 nm, e.g., of more than about 200 nm, or of more than about 100 nm. In this regard, it is to be understood that whenever the size and/or dimensions of the conductive particles are referred to herein and in the appended claims, this size and these dimensions refer to the conductive particles without capping agent thereon. Depending on the type and amount of capping agent, an entire conductive particle, e.g., a nanoparticle which has the capping agent thereon, may be significantly larger than the core thereof.

By way of non-limiting example, not more than about 5%, e.g., not more than about 2%, not more than about 1%, or not more than about 0.5% of the conductive particles, e.g., conductive nanoparticles whether metallic or non-metallic, may be particles whose largest dimension (and/or diameter) is larger than about 200 nm, e.g., larger than about 150 nm, or larger than about 100 nm. In a particularly preferred aspect, at least about 90%, e.g., at least about 95%, of the conductive particles will have a size of not larger than about 80 nm and/or at least about 80% of the conductive particles will have a size of from about 20 nm to about 70 nm. For example, at least about 90%, e.g., at least about 95% of the conductive particles may have a size of from about 30 nm to about 50 nm.

In another aspect, the conductive particles, e.g., conductive nanoparticles whether metallic or non-metallic, may have an average particle size (number average) of at least about 10 nm, e.g., at least about 20 nm, or at least about 30 nm, but preferably not higher than about 80 nm, e.g., not higher than about 70 nm, not higher than about 60 nm, or not higher than about 50 nm. For example, the conductive particles may have an average particle size in the range of from about 25 nm to about 75 nm.

In yet another aspect of the present invention, at least about 80 volume percent, e.g., at least about 90 volume percent of the conductive particles, e.g., conductive nanoparticles whether metallic or non-metallic, may be not larger than about 2 times, e.g., not larger than about 1.5 times, the average particle size (volume average).

The concentration or loading of the conductive phase precursor (e.g., conductive particles such as conductive nanoparticles (whether metallic or non-metallic), or metal precursor) in the ink may vary widely depending, for example, on the desired resistivity of the resistor to be formed from the ink, the conductivity of the conductive phase to be formed form the conductive phase precursor, the resistivity of the resistive phase to be formed from the resistive phase precursor, as well as treating conditions.

If the conductive phase precursor comprises conductive particles, it is preferred for the total loading of conductive particles, e.g., conductive nanoparticles whether metallic or non-metallic, in the inks be not higher than about 75% by weight, such as from about 5% by weight to about 60% by weight, based on the total weight of the ink. Loadings in excess of the preferred amounts can lead to undesirably high viscosities and/or undesirable flow characteristics. Of course, the maximum loading which still affords useful results also depends on the density of the conductive material (e.g., carbon or metal) in the particles. In other words, the higher the density of the conductive material in the nanoparticles, the higher will be the acceptable and desirable loading in weight percent. In preferred aspects, the conductive particle loading is at least about 10% by weight, e.g., at least about 15% by weight, at least about 20% by weight, or at least about 40% by weight. Depending on the metal, the loading will often not be higher than about 65% by weight, e.g., not higher than about 60% by weight. These percentages refer to the total weight of the conductive particles, i.e., including any capping agent carried (e.g., adsorbed) thereon.

As mentioned above, in another embodiment, the conductive phase precursor comprises a metal precursor, which is a compound comprising a metal and capable of being converted, optionally through a reaction with a reducing agent and optionally with the application of heat, to form an elemental metal corresponding to the metal in the metal precursor. Examples of metal precursors include organometallics (molecules with carbon-metal bonds), metal organics (molecules containing organic ligands with metal bonds to other types of elements such as oxygen, nitrogen or sulfur) and inorganic compounds such as metal nitrates, metal halides and other metal salts. Metal precursors are further described in U.S. patent application Ser. No. 11/176,640, filed Jul. 8, 2005, the entirety of which is incorporated herein by reference.

Briefly, the metal in the metal precursor preferably comprises one or more of silver (Ag), nickel (Ni), platinum (Pt), gold (Au), palladium (Pd), copper (Cu), ruthenium (Ru), indium (In) or tin (Sn), with silver being preferred for its high conductivity and copper being preferred for its good conductivity and low cost. In alternative embodiments, the metal in the metal precursor can include one or more of aluminum (Al), zinc (Zn), iron (Fe), tungsten (W), molybdenum (Mo), lead (Pb), bismuth (Bi), cobalt (Co, antimony (Sb) or similar metals. In a preferred embodiment, the metal precursor is soluble in one or more vehicles in the ink, although it is contemplated that the metal precursor may be insoluble in the ink.

In another aspect, the metal precursor comprises a metal oxide, e.g., Ag₂O. In this embodiment, the ink optionally is in the form a colloidal composition rather than a solution, the metal oxide being carried by a carrier medium. Such colloidal compositions may be well-suited for direct write printing applications. When the metal oxide contacts the reducing agent (described below), the metal in the metal oxide is reduced to form the corresponding elemental metal.

In general, metal precursors that eliminate one or more ligands by a radical mechanism upon conversion to the elemental metal are preferred, especially if the intermediate species formed are stable radicals and therefore lower the decomposition temperature of that precursor compound.

In one aspect, metal precursors comprising ligands that eliminate cleanly upon conversion and escape completely from the substrate (or the formed functional structure) are preferred because they are not susceptible to carbon contamination or contamination by anionic species such as nitrates. Therefore, preferred metal precursors for metals used for the conductive phase of the resistors of the invention include carboxylates, alkoxides or combinations thereof that would convert to metals, metal oxides or mixed metal oxides by eliminating small molecules such as carboxylic acid anhydrides, ethers or esters. Metal carboxylates, particularly halogenocarboxylates such as fluorocarboxylates, are particularly preferred metal precursors due to their high solubility.

In several preferred aspects of the invention, the metal precursor comprises a metal nitrate (e.g., silver nitrate, copper nitrate or nickel nitrate) or a metal carboxylate (e.g., silver carboxylate, copper carboxylate or nickel carboxylate).

In one embodiment, as discussed above, a metal precursor or metal oxide precursor is employed as a fusing agent to form a fusing material that secures or adheres adjacent resistive particles to one another to form a single phase resistor. In this embodiment, the fusing agent is employed to form a fusing material that connects adjacent resistive particles to one another, wherein the fusing material comprises the same material as the material that forms the resistive particles. In this embodiment, the fusing material builds up between adjacent particles to improve overall connectivity (physical and electrical) between adjacent particles.

In another embodiment, a metal precursor or metal oxide precursor is employed as a fusing agent to form a fusing material that secures or adheres adjacent conductive particles to one another if, for example, the fusing material acts as the resistive phase. Alternatively, a metal precursor or metal oxide precursor is employed as a fusing agent to form a fusing material that secures or adheres adjacent resistive particles to one another if, for example, the fusing material acts as a conductive phase. In these embodiment, for example, the fusing medium formed from the fusing agent acts as the conductive phase and connects adjacent resistive particles to one another or, alternatively, the fusing medium formed from the fusing agent acts as the resistive phase and connects adjacent conductive particles to one another.

In another embodiment, the fusing material is added to a two-particle system comprising conductive particles and resistive particles. In this embodiment, the fusing agent forms a fusing material that secures or adheres adjacent conductive particles to adjacent resistive particles, conductive particles to adjacent conductive particles and/or resistive particles to adjacent resistive particles.

A non-limiting list of metal precursors and metal oxide precursors that may be employed as fusing agents in these embodiments includes metal acetates (e.g., neodecanoate and acetate) or metal acetonates (e.g., acetylacetonate). Exemplary metal acetates include, but are not limited to silver neodecanoate, silver acetate and ruthenium acetate. Exemplary metal acetonates include, but are not limited to, ruthenium acetylacetonate. In this embodiment, the metal precursor as fusing agent forms a metal that connects adjacent particles. In these embodiment, the fusing agent may be derived from the ink or inks that contain one or more of the conductive particles and/or resistive particles, or may be derived from a separate ink.

As discussed above, two or more metal precursors can be combined in the ink to form metal alloys and/or metal compounds. For example, preferred combinations of metal precursors to form alloys based on silver include: Ag-nitrate and Pd-nitrate; Ag-acetate and [Pd(NH₃)₄](OH)₂; Ag-trifluoroacetate and [Pd(NH₃)₄](OH)₂; and Ag-neodecanoate and Pd-neodecanoate. One particularly preferred combination of metal precursors is Ag-trifluoroacetate and Pd-trifluoroacetate. Another preferred alloy is Ag/Cu.

The amount of metal precursor in the first ink may vary widely depending, for example, on the type of desired application process, the relative amount of metal in the entire metal precursor and other factors. In various embodiments, the first ink optionally comprises the metal in the metal precursor in an amount greater than about 1 weight percent, e.g., greater than about 5 weight percent or greater than about 10 weight percent, based on the total weight of the first ink. In terms of upper range limits, the first ink optionally comprises the metal in the metal precursor in an amount less than about 75 weight percent, e.g., less than about 50 weight percent or less than about 30 weight percent, based on the total weight of the first ink. In terms of ranges, the first ink optionally comprises the metal in the metal precursor in an amount from about 1 to about 50 weight percent, e.g., from about 5 to about 30 or from about 10 to about 20 weight percent, based on the total weight of the first ink.

A metal precursor optionally is utilized in conjunction with a reducing agent (optionally derived from a separate ink) to facilitate the formation of the elemental metal. Optionally, the ink comprising the conductive phase precursor and the resistive phase precursor further comprises a reducing agent. The reducing agent may facilitate the conversion of a metal precursor (or precursors) to its corresponding metal or alloy. Additionally or alternatively, the reducing agent facilitates the conversion of a resistive phase precursor reactant to the resistive phase. The presence of a reducing agent ink may permit the processing temperature to be maintained below the melting temperature of the substrate, whereas the processing temperature may exceed those limits without use of the reducing agent. In another embodiment, a separate ink delivers the reducing agent onto the substrate before, during or after deposition of the ink comprising the conductive phase precursor and the resistive phase precursor.

In a preferred embodiment, the reducing agent is selected from the group consisting of alcohols, aldehydes, amines, amides, alanes, boranes, borohydrides, aluminohydrides and organosilanes. More preferably, the primary reducing agent is selected from the group consisting of alcohols, amines, amides, boranes, borohydrides and organosilanes.

2. Resistive Phase Precursors

As indicated above, in addition to conductive phase precursor, the ink used to form the resistors of the present invention also comprises a resistive phase precursor. As used herein, the term “resistive phase precursor” means a composition suitable for inclusion in an ink, e.g., a direct write ink (such as a piezo-electric or thermal ink jet ink), preferably a digital ink, and which is capable of forming the resistive phase in a resistor formed from the ink, e.g., through a direct write printing process (such as piezo or thermal ink jet printing) or a digital printing process.

The composition of the resistive phase precursor may vary widely. In one embodiment, the resistive phase precursor comprises resistive particles, preferably resistive nanoparticles, as fully described above, which are dispersible in an ink. If the resistive phase precursor comprises resistive particles, e.g., resistive nanoparticles, the resistive particles preferably have been surface modified to include a dispersing or capping agent on the outer surface thereof. As with the optional capping agent on the conductive particles, the capping agent on the surface of the resistive particles preferably facilitates the dispersing of the resistive particles by inhibiting resistive particle agglomeration. Suitable capping agents for dispersing the resistive particles include surfactants and dispersing agents such as those disclosed in U.S. patent application Ser. No. 11/117,701, filed Apr. 29, 2005, entitled “Multi-Component Particles Comprising Inorganic Nanoparticles Distributed in an Organic Matrix and Processes for Making and Using Same,” the entire disclosure of which is incorporated by reference herein.

In one embodiment, the surface of the resistive particles is modified, e.g., with a capping agent, so as to change the resistance of the resistive particle (optionally in addition to improving particle dispersibility), and, ultimately, of the resistive phase formed in the resistor from the resistive particles. Such surface modifications may be obtained by, for example, attaching a reactive metal-containing species or attaching a non-metal-containing species to the surface of the resistive particles. The resistivity of the resistive particles may be controlled, for example, by controlling the thickness of the capping agent on the resistive particles. By controlling the thickness of the capping agent on the resistive particles, the resistivity of the resistive particles can be carefully “tuned”. Thus, in one embodiment, the resistance of the resistors formed form the inks of the present invention may be controlled primarily by type and thickness of the capping agent of the resistive particles rather than by spacing between particles or limiting contact between the conductive phase and the resistive phase.

If the resistive phase precursor comprises resistive particles, the resistive particles, e.g., resistive nanoparticles, may be moderately conductive. In one embodiment, for example, the resistive particles, e.g., resistive nanoparticles, comprise carbon, e.g., as carbon black or modified carbon black. Although carbon is moderately conductive, the resistive phase precursor (as well as the resistive phase formed therefrom) may comprise carbon if the conductive phase formed from the conductive phase precursor, discussed above, is more conductive than carbon.

In other embodiments, the resistive phase precursor comprises a resistive particle, e.g., resistive nanoparticle, comprising one or more of the following: metal rutile, pyrochlore, or perovskite phase compounds, many of which contain ruthenium. Examples include RuO₂, Pb₂Ru₂O₇₋ₓ (where x is 0 to 1), or SrRuO₃. Other metallic oxides that behave similarly to these ruthenates may be used in the resistive phase precursor, e.g., as resistive particles, preferably resistive nanoparticles. Substitutions for Ru can include Ir, Rh or Os. La and Ta compounds can also be used. Like carbon, although these materials are moderately conductive, the resistive phase precursor (as well as the resistive phase formed therefrom) may comprise one or more of these materials if the conductive phase formed from the conductive phase precursor, discussed above, has a greater conductivity.

Similarly, the resistive phase precursor (e.g., as resistive particles, preferably resistive nanoparticles) optionally comprises a metal ruthenate, a compound having the formula MₓRu_{y}O_{z}, wherein M is a metal selected from the group consisting of: Bi, Ir, Pb, Ti, La, Sr, Ca, Ba, and Cu. Other materials for possible inclusion in the resistive phase precursor, e.g., as resistive particles, preferably resistive nanoparticles, include zinc oxide, indium oxide, metal nitrides that semiconduct, TiN, nickel, nickel oxide (NiO), NiCr, ITO, and conductive glasses.

The resistive particles preferably comprise particles that exhibit a high bulk resistivity (in the absence of the conductive phase) such as, e.g., a bulk resistivity of greater than about 5,000 μΩ-cm, e.g., greater than about 10,000 μΩ-cm, greater than about 50,000 μΩ-cm, or greater than about 100,000 μΩ-cm. The resistive phase precursor optionally comprises insulator particles (e.g., insulator nanoparticles), defined herein as particles exhibiting a resistivity greater than about 100 Ω-cm, e.g., greater than about 1,000 Ω-cm or greater than about 1,000,000 Ω-cm or higher.

In one preferred embodiment, the resistive phase precursor comprises insulator particles, e.g., insulator nanoparticles. As used herein, insulator particles are defined as particles comprising a material having a resistivity greater than about 10⁸ Ω-cm. A non-limiting list of various types of insulator particles includes silica particles, alumina particles, titania particles, borosilicate glass particles, lead borosilicate glass particles, and lead free glass particles. Thus, the insulator nanoparticles optionally are selected from the group consisting of silica particles, alumina particles, titania particles, borosilicate glass particles, lead borosilicate glass particles, and lead free glass particles.

In one embodiment, the resistive phase precursor comprises resistive particles, e.g., resistive nanoparticles, which comprise glass, preferably low-melting glass. The glass preferably comprises a silicate. For example, the silicate optionally comprises a borosilicate, e.g., a lead borosilicate or a borosilicate comprising one or more of aluminum, zinc, silver, copper, indium, barium and/or strontium.

Methods used for the preparation of resistive particles, e.g., resistive nanoparticles, comprising glass may be found, for example, in U.S. patent application Ser. No. 11/335,727, filed Jan. 20, 2006, entitled “Method of Making Nanoparticulates and Use of the Nanoparticulates to Make Products Using a Flame Reactor,” the entirety of which is incorporated by reference herein.

The size of the resistive particles that may be employed as the resistive phase precursor may vary widely. Some exemplary particle sizes of the resistive particles that may be used in the ink are described above with reference to the resistive particles included in the resistors of the present invention.

According to a preferred aspect of the present invention, the resistive particles, e.g., resistive nanoparticles, exhibit a narrow particle size distribution. A narrow particle size distribution is particularly advantageous for direct-write printing applications because it results in a reduced clogging of the orifice of a direct-write device by large particles and provides the ability to form features having a fine line width, high resolution and acceptable packing density.

The resistive particles, e.g., resistive nanoparticles, for use in the inks of the present invention preferably also show a high degree of uniformity in shape. Preferably, the resistive particles are substantially spherical in shape. In one possible embodiment the resistive nanoparticles comprise agglomerates of spherical nanoparticles that can be termed “fractal-like” or in some instances resemble “strings of pearls”.

In a preferred aspect of the present invention, at least about 90%, e.g., at least about 95%, or at least about 99% of the resistive particles, e.g., resistive nanoparticles, comprised in the ink are substantially spherical in shape. In another preferred aspect, the ink is substantially free of resistive particles in the form of flakes.

In yet another preferred aspect, the resistive particles are substantially free of micron-size particles, i.e., particles having a size of about 1 micron or above. Even more preferably, the resistive particles may be substantially free of particles having a size (=largest dimension, e.g., diameter in the case of substantially spherical particles) of more than about 500 nm, e.g., of more than about 200 nm, or of more than about 100 nm.

By way of non-limiting example, not more than about 5%, e.g., not more than about 2%, not more than about 1%, or not more than about 0.5% of the resistive particles, e.g., resistive nanoparticles, may be particles whose largest dimension (and/or diameter) is larger than about 200 nm, e.g., larger than about 150 nm, or larger than about 100 nm. In a particularly preferred aspect, at least about 90%, e.g., at least about 95%, of the resistive particles will have a size of not larger than about 80 nm and/or at least about 80% of the resistive particles will have a size of from about 20 nm to about 70 nm. For example, at least about 90%, e.g., at least about 95% of the resistive particles may have a size of from about 30 nm to about 50 nm.

In yet another aspect of the present invention, at least about 80 volume percent, e.g., at least about 90 volume percent of the resistive particles, e.g., resistive nanoparticles, may be not larger than about 2 times, e.g., not larger than about 1.5 times the average particle size (volume average).

In another embodiment, the resistive phase precursor comprises a resistive phase precursor reactant, meaning a compound that is chemically converted to the resistive phase either during or after printing of the ink. For example, the resistive phase precursor reactant may comprise molecules that can be converted to metal oxides, glasses-metal oxide, metal oxide-polymer, and other combinations.

Depending on their nature, and without limiting the present invention to any particular reaction or reaction mechanism, resistive phase precursor reactants can be converted to the resistive phase in the following ways:

Hydrolysis/Condensation:

M(OR)ₙ+H₂O→[MOₓ(OR)ₙ₋ₓ]+MO_{y}

Anhydride Elimination:

M(OAc)ₙ→[MO_{x/2}(OAc)ₙ₋ₓ]+x/2Ac₂O→MO_{y}+(n−x)Ac₂O

Ether Elimination:

M(OR)ₙ→[MOₓ(OR)ₙ₋ₓ]+R₂O→MO_{y}+(n−x)R₂O

Ketone Elimination:

M(OOCR)(R′)→MO_{y}+R′RCO

Ester Elimination:

M(OR)ₙ+M′(OAc)ₙ→[MM′Oₓ(OAc)ₙ₋ₓ(OR)ₙ₋ₓ]+ROAc

[MM′Oₓ(OAc)ₙ₋ₓ(OR)ₙ₋ₓ]→MM′O_{y}+(n−x)ROAc

Alcohol-Induced Ester Elimination:

M(OAc)ₙ+HOR→[MOₓ(OAc)ₙ₋ₓ]→MO_{y}

Small Molecule-Induced Oxidation:

M(OOCR)+Me₃NO→MO_{y}+Me₃N+CO₂

Alcohol-Induced Ester Elimination:

MO₂CR+HOR→MOH+RCO₂R (ester)

MOH→MO₂

Ester Elimination:

MO₂CR+MOR→MOM+RCO₂R (ester)

Condensation Polymerization:

MOR+H₂O→(MₐO_{b})OH+HOR

(MₐO_{b})OH+(MₐO_{b})OH→[(MₐO_{b})O(MₐO_{b})O]

A particularly preferred approach is ester elimination.

Various other resistive phase precursors are described in Published U.S. Patent Application No. 2003/0108664 A1, published Jun. 12, 2003, Published U.S. Patent Application No. 2003/0175411 A1, published Sep. 18, 2003, and Published U.S. Patent Application No. 2003/0161959 A1, published Aug. 28, 2003, the entireties of which are incorporated by reference herein.

The concentration or loading of the resistive phase precursor (e.g., resistive particles or resistive phase precursor reactant) in the ink may vary widely depending, for example, on the desired resistivity of the resistor to be formed from the ink, the conductivity of the conductive phase to be formed form the conductive phase precursor, the resistivity of the resistive phase to be formed from the resistive phase precursor, as well as treating conditions.

3. Vehicle

As indicated above, the ink (or inks) used to form the resistors of the present invention preferably includes a vehicle, which imparts flowability to the ink, optionally in combination with one or more other compositions. If the ink comprises particles, e.g., metallic particles (as the conductive phase precursor) or resistive phase particles (as the resistive phase precursor), the vehicle preferably comprises a liquid that is capable of stably dispersing these particles, which optionally carry a capping agent thereon, e.g., capable of affording a dispersion that can be kept at room temperature for several days or even one, two, three weeks or months or even longer without substantial agglomeration and/or settling of the particles. To this end, it is preferred for the vehicle and/or individual components thereof to be compatible with the surface of the particles, e.g., to be capable of interacting (e.g., electronically and/or sterically and/or by hydrogen bonding and/or dipole-dipole interaction, etc.) with the surface of the conductive and/or resistive particles and in particular, with the optional capping agent. The ink optionally comprises a vehicle in an amount ranging from about 30 to about 85 wt. %, e.g., from about 40 to about 80 wt. %, from about 50 to about 75 wt. % or from about 60 wt. % to about 75 wt. %, based on the total weight of the ink.

It is particularly preferred for the vehicle to be capable of dissolving the capping agent, if present, to at least some extent, for example, in an amount (at 20° C.) of at least about 5 g of capping agent per liter of vehicle, particularly in an amount of at least about 10 g of capping agent, e.g., at least about 15 g, or at least about 20 g per liter of vehicle, preferably in an amount of at least about 100 g, or at least about 200 g per liter of vehicle. In this regard, it is to be appreciated that these preferred solubility values are merely a measure of the compatibility between the vehicle and the capping agent. They are not to be construed as indications that, in the inks, the vehicle is intended to actually dissolve the capping agent and remove it from the surface of the nanoparticles.

In view of the preferred interaction between the vehicle and/or individual components thereof and the capping agent on the surface of the conductive and/or resistive particles, e.g., nanoparticles, the most advantageous vehicle and/or component thereof for the ink(s) is largely a function of the nature of the capping agent. For example, a capping agent which comprises one or more polar groups such as, e.g., a polymer like polyvinylpyrrolidone will advantageously be combined with a vehicle which comprises (or predominantly consists of) one or more polar components (solvents) such as, e.g., a protic solvent, whereas a capping agent which substantially lacks polar groups will preferably be combined with a vehicle which comprises, at least predominantly, aprotic, non-polar components.

Particularly if the ink(s) are intended for use in direct-write applications such as, e.g., ink-jet printing, the vehicle is preferably selected to also satisfy the requirements imposed by the direct-write method and tool such as, e.g., an ink-jet head, particularly in terms of viscosity and surface tension of the ink(s). These requirements are discussed in more detail further below. Another consideration in this regard is the compatibility of the nanoparticle composition with the substrate in terms of, e.g., wetting behavior (contact angle with the substrate).

In a preferred aspect, the vehicle in the ink(s) may comprise a mixture of at least two solvents, preferably at least two organic solvents, e.g., a mixture of at least three organic solvents, or at least four organic solvents. The use of more than one solvent is preferred because it allows, inter alia, to adjust various properties of a composition simultaneously (e.g., viscosity, surface tension, contact angle with intended substrate etc.) and to bring all of these properties as close to the optimum values as possible.

The solvents comprised in the vehicle may be polar or non-polar or a mixture of both, mainly depending on the nature of the capping agent. The solvents should preferably be miscible with each other to a significant extent. Non-limiting examples of solvents that are useful for the purposes of the present invention include alcohols, polyols, amines, amides, esters, acids, ketones, ethers, water, saturated hydrocarbons, and unsaturated hydrocarbons. If the vehicle comprises water, it optionally comprises water in an amount greater than about 50 weight percent, e.g., an amount greater than about 60, greater than about 70 or greater than about 80 weight percent, based on the total weight of the vehicle. Conversely, the vehicle may comprise not more than about 5 weight percent of water, e.g., not more than about 2 weight percent, or not more than about 1 weight percent of water, based on the total weight of the vehicle. For example, the vehicle may be substantially anhydrous.

As discussed in more detail below, when selecting a solvent combination for the liquid vehicle, it is desirable to also take into account the requirements, if any, imposed by the deposition tool (e.g., in terms of viscosity and surface tension of the ink) and the surface characteristics (e.g., hydrophilic or hydrophobic) of the intended substrate. In preferred inks, particularly those intended for ink-jet printing with a piezo head, the preferred viscosity thereof (measured at 20° C.) is not lower than about 5 cP, e.g., not lower than about 8 cP, or not lower than about 10 cP, and not higher than about 30 cP, e.g., not higher than about 20 cP, or not higher than about 15 cP. Preferably, the viscosity shows only small temperature dependence in the range of from about 20° C. to about 40° C., e.g., a temperature dependence of not more than about 0.4 cP/° C. It has surprisingly been found that in the case of preferred use in the present invention the presence of metallic nanoparticles vehicles does not significantly change the viscosity of the vehicle, at least at relatively low loadings such as, e.g., up to about 20 weight percent. This may in part be due to the usually large difference in density between the vehicle and the nanoparticles which manifests itself in a much lower number of particles than the number of particles that the mere weight percentage thereof would suggest.

An ink jet ink suitable for a thermal or piezo-electric ink jet printing process preferably has a surface tension in the range of about 20 to about 60 dynes/cm. More specifically, the preferred inks used to form the security features of the present invention exhibit preferred surface tensions (measured at 20° C.) of not lower than about 20 dynes/cm, e.g., not lower than about 25 dynes/cm, or not lower than about 30 dynes/cm, and not higher than about 40 dynes/cm. In one embodiment, the ink composition or formulation used to form the security features comprises metallic particles and/or metallic nanoparticles, and has a viscosity less than about 60 cP, e.g., less than about 30 cP or less than about 20 cP.

In one preferred embodiment, the ink is suitable for a thermal ink jet printing process. For thermal ink jet printing applications, the ink preferably has a viscosity (measured at 20° C.) that is greater than about 0.5 cP, e.g., greater than about 1.0 cP, or greater than about 1.3 cP, and less than about 10 cP, e.g., less than about 7.5 cP, less than about 5 cP, or less than about 4 cP.

For thermal ink jet applications, the inks of the invention preferably comprise less than about 50 weight percent, e.g., less than about 30 weight percent, less than about 20 weight percent or less than about 10 weight percent, volatile organic compounds (VOC), e.g., as a portion of the vehicle, based on the total weight of the ink. As used herein, the term “volatile organic compounds” are organic compounds that have high enough vapor pressures under normal conditions to significantly vaporize and enter the atmosphere. Low VOC formulations for both thermal and piezo-electric ink jet inks are desirable in manufacturing and printing in order to meet environmental regulations.

4. Additives

The inks used to form the resistors of the present invention also may include one or more additives, such as, but not limited to, an adhesion promoter, a binder, a fusing agent, a reducing agent, a rheology modifier, a wetting angle modifier, a humectant, a crystallization inhibitor, a surfactant, etc.

The ink optionally includes an adhesion promoter for improving the adhesion of the conductive phase and resistive phase to the underlying substrate. It has been found that resistors made from the inks described herein show a satisfactory to excellent adhesion to various substrates without the presence of adhesion promoters.

Especially in the case of glass surfaces, the adhesion of the inks can be (significantly) improved by the addition of an adhesion promoter. Non-limiting examples of adhesion promoters that may be included in the ink(s) include metals as well as metal compounds which are oxides or can be converted to oxides by thermal decomposition, oxidation in an oxygen containing atmosphere, etc. Non-limiting examples of metals for the adhesion promoter include B, Si, Pb, Cu, Zn, Ni and Bi. Especially in the case of a glass substrate, a low melting point glass is yet another example of a suitable adhesion promoter. A specific example of a preferred adhesion promoter is bismuth nitrate (which decomposes to form bismuth oxide at a temperature of about 260° C.). By way of non-limiting example, an atomic ratio Ag:Bi in the range of from about 15:1 to about 7:1 may be particularly advantageous. The addition of bismuth nitrate results in a consistently good adhesion of deposited silver to glass surfaces over the entire tested temperature range of from about 100° C. to about 550° C. Further non-limiting examples of adhesion promoters for use in the present invention are disclosed in, e.g., U.S. Pat. No. 5,750,194, the entire disclosure whereof is incorporated by reference herein in its entirety. Furthermore, polymers such as, e.g., polyamic acid, acrylics and styrene acrylics can improve the adhesion of a metal to a polymer substrate, as can substances such as coupling agents, e.g., titanates and silanes.

An adhesion promoter can also be added to the ink in the form of a metal precursor to a metal (e.g., a chemical precursor to a metal) such as, e.g., in the form of a metal salt (e.g., a carboxylate or nitrate), a metal alkoxide, etc. Adhesion promoters can also be applied to the substrate prior to printing of a nanoparticle ink, preferably by the same printing method but optionally also by an alternative method such as, e.g., spin coating or dip coating.

The inks used to form the resistors optionally include rheology modifiers. Non-limiting examples of rheology modifiers that are suitable for use in the present invention include SOLTHIX 250 (Avecia Limited), SOLSPERSE 21000 (Avecia Limited), styrene allyl alcohol (SAA), ethyl cellulose, carboxy methylcellulose, nitrocellulose, polyalkylene carbonates, ethyl nitrocellulose, and the like. These additives can reduce spreading of the inks after deposition, as discussed in more detail below.

The ink or inks optionally further include additives such as, e.g., wetting angle modifiers, humectants, crystallization inhibitors and the like. Of particular interest are crystallization inhibitors as they prevent crystallization and the associated increase in surface roughness and film uniformity during curing at elevated temperatures and/or over extended periods of time.

Also, the inks optionally comprise added binder, e.g., polymeric binder. In this regard it is to be noted that, in the case of polymeric capping agents such as, e.g., polyvinylpyrrolidone, the capping agent itself may serve as a binder.

In another aspect, the ink comprises a conductive polymer binder, e.g., polyaniline (PANI), polypyrrole, poly(3,4-ethylenedioxythiophene) (PEDOT), PEDOT:PSS (described below). Thus, the ink optionally comprises a binder selected from the group consisting of PANI, polypyrrole, PEDOT, and PEDOT:PSS. In various embodiments, the ink comprises the conductive polymer binder in an amount ranging from about 0.1 to about 40 wt. %, e.g., from about 0.1 to about 30 wt. % or from about 0.2 to about 5 wt. %, based on the total weight of the ink.

PEDOT is a conducting polymer based on 3,4-ethylenedioxylthiophene or EDOT monomer. Depending on target resistivity of the ink, PEDOT can act as either a conductive or a resistive phase. PEDOT binders are moderately conductive, rigid aqueous-based polymers that may eliminate the problems associated with traditional insulating binders because it provides a conduction path between adjacent particles (e.g., conductive particles and/or resistive particles in the ink). Unlike conventional particle-containing resistors, PEDOT binders avoid the dependence on contact points between particles as the primary resistance mechanism. The chemical structure for PEDOT binders is provided below:

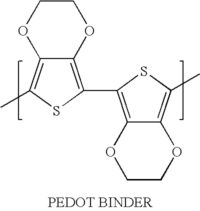

In a related embodiment, the ink comprises a Poly(3,4-ethylenedioxythiophene) poly(styrenesulfonate) (PEDOT:PSS) binder. PEDOT:PSS is a conductive polymer mixture of two ionomers. The first ionomer comprises sodium polystyrene sulfonate, which is a sulfonated polystyrene. Part of the sulfonyl groups are deprotonated and carry a negative charge. The second ionomer comprises PEDOT, which carries a positive charge. Together the charged macromolecules form a macromolecular salt. In the ink, this compound preferably forms a dispersion of gelled particles in a water-based vehicle. The chemical structure for PEDOT:PSS binders is provided below:

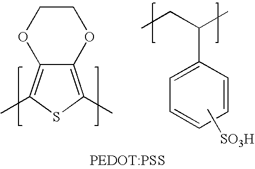

In one embodiment, the ink comprises a temperature coefficient of resistance (TCR) modifier (TCRM). A TCRM can be a source of a metal oxide such as Cu₂O, Ag₂O for the positive direction. Semiconducting oxides of MnO₂, CO₂O₃, TiO₂, Nb₂O₅, Fe₂O₃, R²O₃ and V₂O₅ can shift the TCR in a negative direction. Stabilizers include Al₂O₃, SiO₂ and ZrO₂ and provide stability and reduce sensitivity to processing conditions. The levels of these species is preferably less than about 10 wt. %, e.g., less than 5 wt. %, less than about 2 wt. % or less than about 1 wt. %, based on the total weight of the ink.

A variety of surfactants, either anionic, nonionic, cationic or ampholytic, may also be incorporated in the ink to improve leveling properties of writings formed on impervious writing surfaces. Preferred surfactants include polyoxyethylene carboxylic acid, sulfonic acid, sulfate or phosphate nonionic or anionic surfactants, ampholytic betaine surfactants and fluorinated surfactants. The amount of surfactants optionally is not more than 10% by weight, preferably not more than 5% by weight, based on the total weight of the ink composition. The use of surfactants in excess amounts adversely affects the dispersibility of the resultant ink compositions.

B. Ink Formulations for Forming Resistors from Multiple Inks

In another embodiment, the invention is to a process for forming a resistor from multiple inks, the conductive phase being derived primarily from a first ink and the resistive phase being derived primarily from a second ink. In this embodiment, the process comprises the steps of: (a) providing a first ink comprising a conductive phase precursor and a first vehicle; (b) providing a second ink comprising a resistive phase precursor and a second vehicle; (c) depositing the first ink and the second ink on a substrate; (d) removing a majority of the first vehicle and a majority of the second vehicle from the deposited first and second inks; (e) converting the conductive phase precursor to a conductive phase (optionally during step (d)); and (f) converting the resistive phase precursor to a resistive phase (optionally during step (d)). In this embodiment, the first ink preferably provides a majority of the conductive phase in the resistor, and the second ink provides a majority of the resistive phase in the resistor. By providing conductive and resistive phases from two separate inks, respectively, this embodiment of the invention desirably provides the ability to print resistors having desired electrical characteristics by controlling the amount (and ratio) of conductive phase and resistive phase formed during the process.

It should be understood that the terms “first,” “second,” “third,” etc., as used herein, do not refer to any particular order in which the inks necessarily should be applied or deposited on a substrate. For example, the first ink may be deposited on a substrate before, after or simultaneously with deposition of the second ink. Similarly, a first ink may be deposited on a substrate before, after or simultaneously with deposition of an optional third ink, and a second ink may be deposited on a substrate before, after or simultaneously with deposition of a third ink. It is also contemplated that the first, second and optional third inks may all be deposited on a substrate at the same time. Thus, steps (d), (e) and (f) may occur sequentially (in any order) or at least partially simultaneously.

In this embodiment, the first ink preferably comprises the conductive phase precursor in an amount sufficient to provide more than 50 wt. %, e.g., more than 60 wt. %, more than 70 wt. %, more than 80 wt. % or more than 90 wt. %, of the conductive phase in the ultimately formed resistor. Conversely, in this embodiment, the second ink preferably comprises the resistive phase precursor in an amount sufficient to provide more than 50 wt. %, e.g., more than 60 wt. %, more than 70 wt. %, more than 80 wt. % or more than 90 wt. %, of the resistive phase in the ultimately formed resistor.

The composition of the first ink may be substantially the same as the ink composition described above with reference to the process for forming a resistor from a single ink—the primary difference being the resistive phase precursor is absent from the first ink or is present in the first ink in only a minor amount, i.e., in an amount that provides less than 50 weight percent, e.g., less than 40 wt. %, less than 30 wt. %, less than 20 wt. % or less than 10 wt. %, of the resistive phase to the ultimately-formed resistor, based on the total weight of the resistive phase in the resistor. Thus, subject to this exception, for the sake of brevity, the ink description provided above, with reference to the process for forming a resistor from a single ink, is incorporated in this section in its entirety as if it described the composition of the first ink.

Similarly, the composition of the second ink may be substantially the same as the ink composition described above with reference to the process for forming a resistor from a single ink—the primary difference being the conductive phase precursor is absent from the second ink or is present in the second ink in only a minor amount, i.e., in an amount that provides less than 50 weight percent, e.g., less than 40 wt. %, less than 30 wt. %, less than 20 wt. % or less than 10 wt. %, of the conductive phase to the ultimately-formed resistor, based on the total weight of the conductive phase in the resistor. Thus, subject to this exception, for the sake of brevity, the ink description provided above, with reference to the process for forming a resistor from a single ink, is incorporated in this section in its entirety as if it described the composition of the second ink.

The specific choice of conductive phase precursor and resistive phase precursor implemented in the first and second inks, respectively, may vary widely. Some preferred conductive phase precursor/resistive phase precursor combinations are provided below in Table 4.

TABLE 4
VARIOUS CONDUCTIVE PHASE PRECURSOR/RESISTIVE PHASE
PRECURSOR COMBINATIONS FOR THE FIRST AND
SECOND INKS

| First Ink | Second Ink |
|---|---|
| Metal Precursor | Modified Carbon Black |
| Metal Nanoparticles | Modified Carbon Black |
| Metal Precursor | Modified Carbon Black |
| Metal Precursor | Modified Carbon Black & |
| | Reducing Agent |
| Metal Precursor | Insulator Particles |
| Metal Precursor | Insulator Particles |
| Metal Precursor | Insulator Particles & |
| | Reducing Agent |
| Metal Nanoparticles | Insulator Particles |
| Metal Nanoparticles | Metal Ruthenate Particles |
| Modified Carbon Black | Insulator Particles |
| Modified Carbon Black | Metal Oxide Particles |
| Modified Carbon Black | Metal Ruthenates |
| Metal Oxide Particles | Modified Carbon Black |
| Metal Oxide Particles | Insulator Particles |
| Conductive Glass Particles | Insulator Particles |
| Metal Ruthenate Particles | Insulator Particles |

Of course, those skilled in the art should understand that each respective ink provided above in Table 4 may include components in addition to those presented in the Table. For example, if the Table indicates that the first ink contains a metal precursor, it should be understood the that first ink may contain one or more ingredients in addition to the metal precursor, such as, for example, a vehicle, capping agent, reducing agent, as well as one or more additives.

C. Substrates

Preferred inks according to the present invention can be deposited and converted to resistors at low temperatures, thereby enabling the use of a variety of substrates having a relatively low softening (melting) or decomposition temperature.

Non-limiting examples of substrates that are particularly advantageous according to the present invention include substrates comprising one or more of fluorinated polymer, polyimide, epoxy resin (including glass-filled epoxy resin), polycarbonate, polyester, polyethylene, polypropylene, polyvinyl chloride, ABS copolymer, synthetic paper, flexible fiberboard, non-woven polymeric fabric, cloth and other textiles. Other particularly advantageous substrates include cellulose-based materials such as wood or paper, and metallic foil and glass (e.g., thin glass). The substrate may be coated. Although the inks can be used particularly advantageously for temperature-sensitive substrates, it is to be appreciated that other substrates such as, e.g., metallic and ceramic substrates can also be used in accordance with the present invention.

Of particular interest for display applications are glass substrates and ITO coated glass substrates. Other glass coatings that the metal features may be printed on in flat panel display applications include semiconductors such as c-Si on glass, amorphous Si on glass, poly-Si on glass, and organic conductors and semiconductors printed on glass. The glass may also be substituted with, e.g., a flexible organic transparent substrate such as PET or PEN. The metal or alloy (e.g., Ag) may also be printed on top of a black layer or coated with a black layer to improve the contrast of a display device. Other substrates of particular interest include printed circuit board substrates such as FR4, textiles including woven and non-woven textiles.

Another substrate of particular interest is natural or synthetic paper, in particular, paper that has been coated with specific layers to enhance gloss and accelerate the infiltration of ink solvent or liquid vehicle. A preferred example of a glossy coating for ink-jet paper includes alumina nanoparticles such as fumed alumina in a binder. Also, a silver ink according to the present invention that is ink-jet printed on EPSON glossy photo paper and heated for about 30 min. at about 100° C. is capable of exhibiting highly conductive Ag metal lines with a bulk conductivity in the 10 micro-Ω cm range.

According to a preferred aspect of the present invention, the substrate onto which the ink or inks are deposited may have a softening and/or decomposition temperature of not higher than about 225° C., e.g., not higher than about 200° C., not higher than about 185° C., not higher than about 150° C., or not higher than about 125° C.

D. Ink Deposition and Optional Treating

The ink(s) can be deposited onto surfaces, e.g., substrate surfaces, using a variety of tools such as, e.g., low viscosity deposition tools. As used herein, a low viscosity deposition tool is a device that deposits a liquid or liquid suspension onto a surface by ejecting the ink(s) through an orifice toward the surface without the tool being in direct contact with the surface. The low viscosity deposition tool is preferably controllable over an x-y grid, referred to herein as a direct-write deposition tool. A preferred direct-write deposition tool according to the present invention is an ink-jet device, e.g., a piezo-electric or thermal ink jet device. Other examples of direct-write deposition tools include aerosol jets and automated syringes, such as the MICROPEN tool, available from Ohmcraft, Inc., of Honeoye Falls, N.Y.

A preferred direct-write deposition tool for the purposes of the present invention is an ink-jet device. Ink-jet devices operate by generating droplets of the composition and directing the droplets toward a surface. The position of the ink-jet head is carefully controlled and can be highly automated so that discrete patterns of the composition can be applied to the surface. Ink-jet printers are capable of printing at a rate of about 1000 drops per jet per second or higher and can print linear features with good resolution at a rate of about 10 cm/sec or more, up to about 1000 cm/sec. Each drop generated by the ink-jet head includes approximately 25 to about 100 picoliters of the composition, which is delivered to the surface. For these and other reasons, ink-jet devices are a highly desirable means for depositing materials onto a surface.

Typically, an ink-jet device includes an ink-jet head with one or more orifices having a diameter of not greater than about 100 μm, such as from about 50 μm to about 75 μm. Droplets are generated and are directed through the orifice toward the surface being printed. Ink-jet printers typically utilize a piezoelectric driven system to generate the droplets, although other variations are also used. Ink-jet devices are described in more detail in, for example, U.S. Pat. Nos. 4,627,875 and 5,329,293, the disclosures whereof are incorporated by reference herein in their entireties.

The ink(s) can also be deposited by aerosol jet deposition. Aerosol jet deposition allows the formation of resistors having a feature width of, e.g., not greater than about 200 μm, such as not greater than about 150 μm, not greater than about 100 μm and even not greater than about 50 μm. In aerosol jet deposition, the ink is aerosolized into droplets and the droplets are transported to the substrate in a flow gas through a flow channel. Typically, the flow channel is straight and relatively short.

The ink(s) can also be deposited by a variety of other techniques including, liquid embossing after spin coating the ink, stamping, intaglio, roll printer, spraying, dip coating, spin coating, and other techniques that direct discrete units of fluid or continuous jets, or continuous sheets of fluid to a surface. Other examples of advantageous printing methods for the compositions of the present invention include lithographic printing and gravure printing.

The step of removing the vehicle(s) optionally comprises heating and/or curing the deposited ink(s) (e.g., single ink or first and second inks, separately or simultaneously) under conditions effective to remove the majority of the vehicle(s) (e.g., first and second vehicles). The removing step also may cause adjacent conductive phase particles, formed from the conductive phase precursor, and/or adjacent resistive phase particles, formed from the resistive phase precursor, to sinter to one another during formation of the resistor.

During the step of removing the vehicle from the ink(s), the capping agent (if present) preferably is removed or transferred away from the surface of the particles (if any), at least partially, in order to provide increased touching or necking between adjacent metallic nanoparticles and/or resistive particles.

The properties of the deposited ink(s) can also be subsequently modified. This can include freezing, melting and otherwise modifying the properties such as viscosity with or without chemical reactions or removal of material from the ink(s). For example, an ink including a UV-curable polymer can be deposited and immediately exposed to an ultraviolet lamp to polymerize and thicken and reduce spreading of the composition. Similarly, a thermoset polymer can be deposited and exposed to a heat lamp or other infrared light source.

After deposition, the ink(s) may be treated to convert the ink(s) to the desired structure and/or material, e.g., a resistor. The treatment can include multiple steps, or can occur in a single step, such as when the ink(s) are rapidly heated and held at the processing temperature for a sufficient amount of time to form a resistor. If the resistor is formed from multiple inks, each respective deposited ink may be treated (e.g., heated or cured) separately, at the same time as another ink, or a combination thereof.

An ink that has been applied (e.g., printed) on a substrate may be cured by a number of different methods including, but not limited to thermal, IR, UV, microwave heating and pressure-based curing. By way of non-limiting example, thermal curing can be effected by removing the vehicle (solvents) at low temperatures. On some substrates such as paper, no thermal curing step may be necessary, while in others a mild thermal curing step such as, e.g., short exposure to an infra-red lamp may be sufficient. In this particular embodiment, the ink may have a higher absorption cross-section for the IR energy derived from the heat lamp compared to the surrounding substrate and so the applied composition may be preferentially thermally cured.

An optional, initial step may include drying or subliming of the composition by heating or irradiating. In this step, the liquid vehicle (e.g., solvent) is removed from the deposited ink(s) and/or chemical reactions occur in the composition. Non-limiting examples of methods for processing the deposited composition in this manner include methods using a UV, IR, laser or a conventional light source. Heating rates for drying the ink(s) are preferably greater than about 10° C./min., more preferably greater than about 100° C./min. and even more preferably greater than about 1000° C./min. The temperature of the deposited inks(s) can be raised using hot gas or by contact with a heated substrate. This temperature increase may result in further evaporation of vehicle and other species. A laser, such as an

IR laser, can also be used for heating. An IR lamp, a hot plate or a belt furnace can also be utilized. It may also be desirable to control the cooling rate of the deposited feature.

The ink(s) of the present invention can be processed for very short times and still provide useful materials. Short heating times can advantageously prevent damage to the underlying substrate. For example, thermal processing times for deposits having a thickness on the order of about 10 μm may be not greater than about 100 milliseconds, e.g., not greater than about 10 milliseconds, or not greater than about 1 millisecond. The short heating times can be provided using laser (pulsed or continuous wave), lamps, or other radiation. Particularly preferred are scanning lasers with controlled dwell times. When processing with belt and box furnaces or lamps, the hold time may often be not longer than about 60 seconds, e.g., not longer than about 30 seconds, or not longer than about 10 seconds. The heating time may even be not greater than about 1 second when processed with these heat sources, and even not greater than about 0.1 second while still providing conductive materials that are useful in a variety of applications. The preferred heating time and temperature will also depend on the nature of the desired feature, e.g., of the desired electronic feature. It will be appreciated that short heating times may not be beneficial if the solvent or other constituents boil rapidly and form porosity or other defects in the feature.

In one aspect of the present invention, the deposited ink may be converted to a resistor at temperatures (e.g., a maximum temperature) of not higher than about 1,000° C. (for durable substrates such as ceramics), e.g., not higher than about 875° C., not higher than about 700° C., not higher than about 600° C. not higher than about 500° C., not higher than about 400° C., not higher than about 300° C., not higher than about 250° C., not higher than about 225° C., not higher than about 200° C., or even not higher than about 185° C. In terms of ranges, the deposited ink(s) may be converted to a resistor at a temperature (e.g., maximum temperature) of from about 700° C. to about 1000° C. for durable substrates such as ceramics, from about 500° C. to about 700° C. for glass substrates, or below about 400° C. for polymeric substrates. In many cases it will be possible to achieve substantial conductivity at temperatures of not higher than about 150° C., e.g., at temperatures of not higher than about 125° C., or even at temperatures of not higher than about 100° C. Any suitable method and device and combinations thereof can be used for the conversion, e.g., heating in a furnace or on a hot plate, irradiation with a light source (UV lamp, IR or heat lamp, laser, etc.), combinations of any of these methods, to name just a few.

When high conductivity and a dense, high metal-content material are desired, a higher-temperature sintering may be performed (for example, in the range of from about 300° C. to about 550° C.). During such treatment the capping agent may—at least in part—decompose and/or volatilize. As a result, sintering will occur more rapidly and a much denser metal structure may be formed as compared to a low-temperature structure.

The particles optionally contained in the ink(s) or formed from the ink(s) may optionally be sintered, e.g., partially or fully sintered. The sintering can be carried out using, for example, furnaces, light sources such as heat lamps and/or lasers. In one aspect, the use of a laser advantageously provides very short sintering times and in one aspect the sintering time is not greater than about 1 second, e.g., not greater than about 0.1 seconds, or even not greater than about 0.01 seconds. Laser types include pulsed and continuous wave lasers. In one aspect, the laser pulse length is tailored to provide a depth of heating that is equal to the thickness of the material to be sintered.

According to a further non-limiting example, the applied (e.g., printed) resistor may be cured by compression. This may be achieved, for example, by exposing the article comprising the applied composition to any of a variety of different processes that “weld” the nanoparticles in the composition (ink). Non-limiting examples of corresponding processes include stamping and roll pressing. In particular, for applications in the security industry (discussed in detail below), subsequent processing steps in the construction of a secure document may include intaglio printing which will result in the exposure of a substrate comprising a deposited metallic feature to high pressure and temperatures in the range of from, e.g., about 50° C. to about 100° C. The temperature or the pressure or both combined should be sufficient to cure the ink(s) and create a reflective and/or electrical resistor.

It will be appreciated by those skilled in the art that any combination of heating, pressing, UV-curing or any other type of radiation curing may be useful in creating desired properties of a (e.g., printed) feature.

It will be appreciated from the foregoing discussion that two or more of the latter process steps (drying, heating and sintering) can be combined into a single process step. Also, one or more of these steps may optionally be carried out in a reducing atmosphere (e.g., in an H₂/N₂ atmosphere for metals that are prone to undergo oxidation, especially at elevated temperature, such as e.g., Ni) or in an oxidizing atmosphere.

The deposited and treated material, e.g., the electrical resistor of the present invention, may be post-treated. The post-treatment can, for example, include cleaning and/or encapsulation of the electrical resistor (e.g., in order to protect the deposited material from oxygen, water or other potentially harmful substances) or other modifications. The same applies to any other metal structures that may be formed (e.g., deposited) with a nanoparticle composition of the present invention.

In the embodiments of the invention for forming a resistor from multiple inks, the inks may be deposited on the substrate in any of many different patterns to create the resistor. In one embodiment of the present invention, a non-limiting example of which is shown in FIGS. 1a, 1b, and 1c, a dot pattern can be printed using a first ink comprising a conductive phase precursor represented by the symbol A, and a second ink comprising a resistive phase precursor represented by the symbol B. Every symbol represents a single dot of ink-jet printed material printed onto a substrate. A dot may be a single droplet of ink, or a dot may include a group of droplets having a predetermined droplet pattern. FIG. 1a illustrates a first layer of deposited ink, i.e., this first layer is printed directly onto the substrate surface. FIG. 1b illustrates a second layer of deposited ink, i.e., this second layer is printed on top of the first layer, in correspondingly respective positions. FIG. 1c represents a third layer of deposited ink, which is printed on top of the second layer. It is noted that any number of additional layers of electronic ink may be printed, each successively on top of the previous layer.

For descriptive purposes, it is assumed that the substrate surface is coplanar with an X-axis and a Y-axis, and that a Z-axis is orthogonal to the substrate surface. Referring to the implementation illustrated in FIGS. 1a, 1b, and 1c, a Z-axis resistor is printed with a higher electrical conductivity (less resistivity) in the Z direction, and a lower electrical conductivity (higher resistivity) in the X and Y directions. In each of the X and Y directions, every dot of first ink (comprising a conductive phase precursor) is abutted by a dot of second ink (comprising a resistive phase precursor), and every dot of second ink is abutted by a dot first ink. Conversely, in the Z direction, after the first layer has been deposited, every dot of first ink is deposited directly on top of a previously deposited dot of first ink, and every dot of second ink is deposited directly on top of a previously deposited dot of second ink. In this manner, current will tend to flow in the Z direction, from first ink dot to first ink dot, and not in the X or Y directions, where there are no abutting first ink dots. If desired, a resistor can be produced such that the direction of greater conductivity (less resistivity) is either the X direction or the Y direction instead of the Z direction, by selecting an appropriate ink dot layout such that the abutting first ink dots are arranged in the desired direction.

Referring to FIGS. 2a, 2b, and 2c, a second exemplary ink dot layout uses the same inks as shown in FIGS. 1a, 1b, and 1c. A first layer, which is deposited directly onto the substrate surface, is illustrated in FIG. 2a; a second layer, which is deposited on top of the first layer in corresponding positions, is illustrated in FIG. 2b; and a third layer, which is deposited directly on top of the second layer, is illustrated in FIG. 2c. In this example, the second layer has the ink dot positions exactly reversed from each of the first and third layers. Once again, any number of additional layers having the same ink dot layout may be printed, with each successive layer having the exact reverse ink layout as the previously deposited layer.

Referring to FIG. 3, in another exemplary embodiment, of the present invention is to a resistor having a resistivity gradient. In this embodiment, there are more first ink dots (A dots) toward the left side of the device, and the number of second ink dots (B dots) gradually increases from left to right, accordingly the resistivity gradient increases from low to high. This type of device may be useful as a signal line termination application. In a related embodiment, the weight ratio of the conductive phase to the resistive phase is increased, e.g., longitudinally, laterally or both, from a first point on the resistor to a second point on the resistor so as to form a resistor having a resistivity gradient.

Referring to FIG. 4, another exemplary ink dot layout uses the same two inks as shown in FIGS. 1-3. In this example, the resistivity gradient starts at left with a low resistivity, increases to a high resistivity at the center of the device, then decreases back to a low resistivity at the right side of the device. That is, there is an increased concentration of first ink dots at the center of the resistor than at the ends, and, conversely, there is an increased concentration of second ink dots at the ends of the resistor rather than in the center of the resistor. This resistor may be used as a standard resistor to enhance the tolerance of the printed resistor component when there is poor registration between the resistor material and the resistor electrodes.

In another aspect of the present invention, variation in the thickness of the selected first and second inks can be used to produce desired electrical characteristics. By tapering the thickness, material can be conserved. This may translate into cost savings, for example, if a conductive silver ink is used. Thickness variations may also be used to tailor circuit elements based on characteristics such as a desired voltage rating.

The ink dots can be interlaced in various ways. In some applications, two inks that do not blend are used, such as a water-based ink and an oil-based ink. This creates a matrix of two discrete components. The first ink can be printed first and can be cured, either partially or completely, before the second ink is printed. Conversely, the second ink can be printed first and can be cured, either partially or completely, before the first ink is printed.

Alternatively, blendable inks can be partially blended on the substrate. Blending of inks can be accomplished by printing “wet on wet”, e.g., printing the second ink while the printed first ink is still wet and has not yet cured or printing the first ink while the printed second ink is still wet and has not yet cured. Blending may also be accomplished by printing “wet next to wet”, e.g., printing the second ink in positions that directly abut dots of the printed first ink within the same layer prior to curing or printing the first ink in positions that directly abut dots of the printed second ink within the same layer prior to curing. The quality of such blends is enhanced by selecting inks formulations that can be blended easily. The ability to blend of multiple inks (e.g., first and second inks) desirably allows the fabrication of resistors having a wide range of resistances with a small number of inks, e.g., 2, 3 or 4 inks. In this embodiment, the first and second inks preferably are deposited within a minute (e.g., within 30 seconds or within 15 seconds; or simultaneously to about 1 second, or about 1 second to about 10 seconds, or about 10 seconds to about 30 seconds, or about 30 seconds to 1 minute) of one another. In another embodiment, the first and second inks preferably are deposited within 10 minutes (e.g., from about 1 minute to 10 minutes) of one another.

In addition, for applications that use gradients, such as the graded resistor illustrated in FIG. 3, inks may be selectively chosen such that the gradient is smoothed out because the electrical characteristics of the chosen inks are relatively close in magnitude. For example, for the graded resistor of FIG. 3, a choice of first and second inks whose resistivities are unequal but close in magnitude will enable the gradient to be a smooth, gradual gradient. By contrast, for applications in which a sharp, discrete distinction is needed, first and second inks having sharply distinct characteristic values may be chosen to accentuate the desired application. Additional patterns are described in co-pending U.S. patent application Ser. Nos. 11/331,237, filed Jan. 13, 2006, and Ser. No. 11/331,186, filed Jan. 13, 2006, the entireties of which are incorporated by reference herein.

### III. Examples

The present invention will be better understood in view of the following non-limiting examples.

### Example 1

### Silver/Modified Carbon Black Resistor

A 10 weight percent modified carbon black dispersion in a 50%/50% by mass mixture of ethanol and glycol was ink jet printed as the “second ink” onto an organic substrate and dried at below 100° C. After deposition and drying of the second ink, a first ink comprising a dispersion of silver nanoparticles was printed over the dried modified carbon black and the resulting structure was heated to a maximum temperature less than 300° C. to form a resistor.

It is noted that the foregoing examples have been provided merely for the purpose of explanation and are in no way to be construed as limiting of the present invention. While the present invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

We claim:

1. A resistor, comprising a network of interconnected conductive nodes and resistive nodes, wherein the conductive nodes comprise conductive nanoparticles, and wherein the resistive nodes comprise resistive particles, the network defining a plurality of pores having an average pore volume of less than about 10,000,000 nm³, and the resistor having a resistivity of greater than 100 μΩ-cm.

2. The resistor of claim 1, wherein the resistivity is greater than 1,000 μΩ-cm.

3. The resistor of claim 1, wherein the resistivity is greater than 1,000,000 μΩ-cm.

4. The resistor of claim 1, wherein a majority of the conductive nanoparticles are fused to at least one adjacent conductive nanoparticle.

5. The resistor of claim 1, wherein the conductive nanoparticles comprise metallic nanoparticles.

6. The resistor of claim 5, wherein the metallic nanoparticles comprise a metal selected from the group consisting of silver, gold, copper, nickel, cobalt, palladium, platinum, indium, tin, zinc, titanium, chromium, tantalum, tungsten, iron, rhodium, iridium, ruthenium, osmium, aluminum and lead.

7. The resistor of claim 6, wherein the resistive particles comprise carbon nanoparticles.

8. The resistor of claim 7, wherein the carbon nanoparticles comprise modified carbon black.

9. The resistor of claim 5, wherein the metallic nanoparticles comprise an alloy comprising at least two metals, each of the two metals being selected from the group consisting of silver, gold, copper, nickel, cobalt, palladium, platinum, indium, tin, zinc, titanium, chromium, tantalum, tungsten, iron, rhodium, iridium, ruthenium, osmium, aluminum and lead.

10. The resistor of claim 5, wherein the metallic nanoparticles comprise an alloy comprising a combination of metals selected from the group consisting of silver/nickel, silver/copper, silver/cobalt, platinum/copper, platinum/ruthenium, platinum/iridium, platinum/gold, palladium/gold, palladium/silver, nickel/copper, nickel/chromium, and titanium/palladium/gold.

11. The resistor of claim 1, wherein the conductive nanoparticles comprise modified carbon black.

12. The resistor of claim 11, wherein the resistive particles comprise insulator nanoparticles.

13. The resistor of claim 12, wherein the insulator nanoparticles are selected from the group consisting of silica particles, alumina particles, titania particles, borosilicate glass particles, lead borosilicate glass particles, and lead free glass particles.

14. The resistor of claim 13, wherein the insulator nanoparticles are functionalized with functional groups.

15. The resistor of claim 14, wherein the functional groups are selected from the groups consisting of acrylate groups, perfluoro groups, alcohol groups, epoxide groups and aliphatic alkane groups.

16. The resistor of claim 1, wherein the conductive nanoparticles comprise a metal ruthenate.

17. The resistor of claim 1, wherein the conductive nanoparticles have an average particle size of from about 20 to about 500 nm.

18. The resistor of claim 1, wherein the weight ratio of the conductive phase to the resistive phase increases from a first point on the resistor to a second point on the resistor.

19. The resistor of claim 1, wherein the resistor further comprises a binder comprising PEDOT.

20. A resistor, comprising:
(a) a conductive phase disposed on a substrate, the conductive phase comprising conductive nanoparticles; and
(b) a resistive phase in electrical communication with the conductive phase.

21. The resistor of claim 20, wherein the resistive phase comprises a fusing material that has a conductivity less than the conductivity of the conductive phase and which connects adjacent conductive nanoparticles to one another.

22. The resistor of claim 20, wherein the resistor comprises interconnected particles having core/shell structures, wherein the cores comprise the conductive phase and the shells comprise the resistive phase.

23. The resistor of claim 22, wherein the cores comprise a metal selected from the group consisting of silver, nickel and copper, and wherein the shells comprise silica.

24. The resistor of claim 20, wherein the resistive phase is separate from the conductive phase.

25. The resistor of claim 24, wherein the resistive phase is longitudinally oriented, at least in part, with respect to the conductive phase.

26. The resistor of claim 24, wherein the resistive phase is laterally oriented, at least in part, with respect to the conductive phase.

27. The resistor of claim 24, wherein the resistor comprises multiple conductive phases and multiple resistive phases alternating longitudinally with respect to one another.

28. The resistor of claim 24, wherein the resistor comprises a checkerboard pattern of alternating conductive phases and resistive phases.

29. The resistor of claim 24, wherein the conductive nanoparticles comprise metallic nanoparticles.

30. The resistor of claim 29, wherein the metallic nanoparticles comprise a metal selected from the group consisting of silver, gold, copper, nickel, cobalt, palladium, platinum, indium, tin, zinc, titanium, chromium, tantalum, tungsten, iron, rhodium, iridium, ruthenium, osmium, aluminum and lead.

31. The resistor of claim 20, wherein the resistive phase comprises carbon nanoparticles.

32. The resistor of claim 31, wherein the carbon nanoparticles comprise modified carbon black.

33. The resistor of claim 29, wherein the metallic nanoparticles comprise an alloy comprising at least two metals, each of the two metals being selected from the group consisting of silver, gold, copper, nickel, cobalt, palladium, platinum, indium, tin, zinc, titanium, chromium, tantalum, tungsten, iron, rhodium, iridium, ruthenium, osmium, aluminum and lead.

34. The resistor of claim 29, wherein the metallic nanoparticles comprise an alloy comprising a combination of metals selected from the group consisting of silver/nickel, silver/copper, silver/cobalt, platinum/copper, platinum/ruthenium, platinum/iridium, platinum/gold, palladium/gold, palladium/silver, nickel/copper, nickel/chromium, and titanium/palladium/gold.

35. The resistor of claim 20, wherein the conductive nanoparticles comprise modified carbon black.

36. The resistor of claim 20, wherein the conductive nanoparticles comprise a metal ruthenate.

37. The resistor of claim 35, wherein the resistive particles comprise insulator nanoparticles.

38. The resistor of claim 37, wherein the insulator nanoparticles are selected from the group consisting of silica particles, alumina particles, titania particles, borosilicate glass particles, lead borosilicate glass particles, and lead free glass particles.

39. The resistor of claim 38, wherein the insulator nanoparticles are functionalized with functional groups.

40. The resistor of claim 39, wherein the functional groups are selected from the groups consisting of acrylate groups, perfluoro groups, alcohol groups, epoxide groups and aliphatic alkane groups.

41. The resistor of claim 20, wherein the conductive nanoparticles have an average particle size of from about 20 to about 500 nm.

42. The resistor of claim 20, wherein the resistor further comprises a binder comprising PEDOT.

43. A resistor comprising resistive nanoparticles and a fusing material connecting adjacent resistive nanoparticles to one another.

44. The resistor of claim 43, wherein the resistive nanoparticles comprise glass nanoparticles.

45. The resistor of claim 43, wherein the resistive nanoparticles comprise modified carbon black.

46. The resistor of claim 43, wherein the resistive nanoparticles comprise a metal ruthenate.

47. The resistor of claim 43, wherein the resistive nanoparticles comprise insulator nanoparticles.

48. The resistor of claim 47, wherein the insulator nanoparticles are selected from the group consisting of silica particles, alumina particles, titania particles, borosilicate glass particles, lead borosilicate glass particles, and lead free glass particles.

49. The resistor of claim 43, wherein the fusing material comprises a metal selected from the group consisting of silver, nickel and copper.

50. A process for forming a resistor, the process comprising the steps of:
(a) providing an ink comprising a conductive phase precursor, a resistive phase precursor and a vehicle;
(b) depositing the ink on a substrate;
(c) removing a majority of the vehicle from the deposited ink;
(d) converting the conductive phase precursor to a conductive phase; and
(e) converting the resistive phase precursor to a resistive phase.

51. The process of claim 50, wherein steps (c), (d) and (e) occur at least partially simultaneously.

52. The process of claim 50, wherein the conductive phase precursor comprises conductive nanoparticles.

53. The process of claim 52, wherein the conductive nanoparticles have an average particle size of from about 20 to about 500 nm.

54. The process of claim 52, wherein the conductive nanoparticles comprise metallic nanoparticles.

55. The process of claim 54, wherein the metallic nanoparticles comprise a metal selected from the group consisting of silver, gold, copper, nickel, cobalt, palladium, platinum, indium, tin, zinc, titanium, chromium, tantalum, tungsten, iron, rhodium, iridium, ruthenium, osmium, aluminum and lead.

56. The process of claim 54, wherein the metallic nanoparticles comprise an alloy comprising at least two metals, each of the two metals being selected from the group consisting of silver, gold, copper, nickel, cobalt, palladium, platinum, indium, tin, zinc, titanium, chromium, tantalum, tungsten, iron, rhodium, iridium, ruthenium, osmium, aluminum and lead.

57. The process of claim 54, wherein the metallic nanoparticles comprise an alloy comprising a combination of metals selected from the group consisting of silver/nickel, silver/copper, silver/cobalt, platinum/copper, platinum/ruthenium, platinum/iridium, platinum/gold, palladium/gold, palladium/silver, nickel/copper, nickel/chromium, and titanium/palladium/gold.

58. The process of claim 52, wherein the conductive nanoparticles comprise modified carbon black.

59. The process of claim 52, wherein the conductive nanoparticles comprise a metal ruthenate.

60. The process of claim 52, wherein the conductive phase precursor further comprises a metal precursor.

61. The process of claim 60, wherein the conductive nanoparticles comprise silver nanoparticles or ruthenium oxide nanoparticles.

62. The process of claim 61, wherein the metal precursor comprises a metal acetate or a metal acetonate.

63. The process of claim 62, wherein the metal acetate comprises silver neodecanoate, silver acetate or ruthenium acetate.

64. The process of claim 62, wherein the metal acetonates comprises acetylacetonate ruthenium.

65. The process of claim 50, wherein the resistive phase precursor comprises resistive nanoparticles.

66. The process of claim 65, wherein the resistive nanoparticles comprise glass nanoparticles.

67. The process of claim 65, wherein the resistive nanoparticles comprise modified carbon black.

68. The process of claim 65, wherein the resistive nanoparticles comprise a metal ruthenate.

69. The process of claim 65, wherein the resistive nanoparticles comprise insulator nanoparticles.

70. The process of claim 69, wherein the insulator nanoparticles are selected from the group consisting of silica particles, alumina particles, titania particles, borosilicate glass particles, lead borosilicate glass particles, and lead free glass particles.

71. The resistor of claim 70, wherein the insulator nanoparticles are functionalized with functional groups.

72. The resistor of claim 71, wherein the functional groups are selected from the groups consisting of acrylate groups, perfluoro groups, alcohol groups, epoxide groups and aliphatic alkane groups.

73. The process of claim 50, wherein the resistive phase precursor comprises a resistive phase precursor reactant.

74. The process of claim 50, wherein the ink further comprises a binder comprising PEDOT.

75. The process of claim 50, wherein the process comprises heating the deposited ink.

76. The process of claim 50, wherein the process comprises curing the deposited ink with UV radiation.

77. The process of claim 50, wherein the depositing comprises direct write printing the ink onto the substrate.

78. A process for forming a resistor, the process comprising the steps of:
(a) providing a first ink comprising a conductive phase precursor and a first vehicle;
(b) providing a second ink comprising a resistive phase precursor and a second vehicle;
(c) depositing the first ink and the second ink on a substrate;
(d) removing a majority of the first vehicle and a majority of the second vehicle from the deposited first and second inks; and
(e) converting the conductive phase precursor to a conductive phase; and
(f) converting the resistive phase precursor to a resistive phase.

79. The process of claim 78, wherein steps (d), (e) and (f) occur at least partially simultaneously.

80. The process of claim 78, wherein the conductive phase precursor comprises conductive nanoparticles.

81. The process of claim 80, wherein the conductive nanoparticles have an average particle size of from about 20 to about 500 nm.

82. The process of claim 80, wherein the conductive nanoparticles comprise metallic nanoparticles.

83. The process of claim 82, wherein the metallic nanoparticles comprise a metal selected from the group consisting of silver, gold, copper, nickel, cobalt, palladium, platinum, indium, tin, zinc, titanium, chromium, tantalum, tungsten, iron, rhodium, iridium, ruthenium, osmium, aluminum and lead.

84. The process of claim 82, wherein the metallic nanoparticles comprise an alloy comprising at least two metals, each of the two metals being selected from the group consisting of silver, gold, copper, nickel, cobalt, palladium, platinum, indium, tin, zinc, titanium, chromium, tantalum, tungsten, iron, rhodium, iridium, ruthenium, osmium, aluminum and lead.

85. The process of claim 82, wherein the metallic nanoparticles comprise an alloy comprising a combination of metals selected from the group consisting of silver/nickel, silver/copper, silver/cobalt, platinum/copper, platinum/ruthenium, platinum/iridium, platinum/gold, palladium/gold, palladium/silver, nickel/copper, nickel/chromium, and titanium/palladium/gold.

86. The process of claim 80, wherein the conductive nanoparticles comprise modified carbon black.

87. The process of claim 80, wherein the conductive nanoparticles comprise a metal ruthenate.

88. The process of claim 80, wherein the conductive phase precursor further comprises a metal precursor.

89. The process of claim 88, wherein the conductive nanoparticles comprise silver nanoparticles or ruthenium oxide nanoparticles.

90. The process of claim 89, wherein the metal precursor comprises a metal acetate or a metal acetonate.

91. The process of claim 90, wherein the metal acetate comprises silver neodecanoate, silver acetate or ruthenium acetate.

92. The process of claim 90, wherein the metal acetonates comprises acetylacetonato ruthenium.

93. The process of claim 78, wherein the resistive phase precursor comprises resistive nanoparticles.

94. The process of claim 93, wherein the resistive nanoparticles comprise glass nanoparticles.

95. The process of claim 93, wherein the resistive nanoparticles comprise modified carbon black.

96. The process of claim 93, wherein the resistive nanoparticles comprise a metal ruthenate.

97. The process of claim 93, wherein the resistive nanoparticles comprise insulator nanoparticles.

98. The process of claim 97, wherein the insulator nanoparticles are selected from the group consisting of silica particles, alumina particles, titania particles, borosilicate glass particles, lead borosilicate glass particles, and lead free glass particles.

99. The process of claim 98, wherein the insulator nanoparticles are functionalized with functional groups.

100. The process of claim 99, wherein the functional groups are selected from the groups consisting of acrylate groups, perfluoro groups, alcohol groups, epoxide groups and aliphatic alkane groups.

101. The process of claim 78, wherein the resistive phase precursor comprises a resistive phase precursor reactant.

102. The process of claim 78, wherein at least one of the first ink or the second ink further comprises a binder comprising PEDOT.

103. The process of claim 78, wherein the process comprises heating at least one of the deposited first ink or the deposited second ink.

104. The process of claim 78, wherein the process comprises curing at least one of the deposited first ink or the deposited second ink with UV radiation.

105. The process of claim 78, wherein the depositing comprises direct write printing at least one of the first ink or the second ink onto the substrate.

106. The process of claim 78, wherein the first ink is deposited before the second ink is deposited.

107. The process of claim 78, wherein the second ink is deposited before the first ink is deposited.

108. The process of claim 78, wherein the removing of the majority of the first vehicle occurs before the depositing of the second ink.

109. The process of claim 78, wherein the removing of the majority of the second vehicle occurs before the depositing of the first ink.

110. The process of claim 78, wherein the depositing comprises printing the first ink and the second ink in a checkerboard pattern of alternating conductive phases and resistive phases.

111. The process of claim 78, wherein the resistor comprises multiple conductive phases and multiple resistive phases alternating longitudinally with respect to one another.

112. The process of claim 78, wherein the first ink and the second ink are deposited within about 30 seconds of one another.

113. The process of claim 78, wherein the first ink and the second ink blend with one another after step (c).
